(19) United States
(12) Patent Application Publication
(10) Pub. No.: US 2022/0193844 A1
(43) Pub. Date: Jun. 23, 2022

(54) MANUFACTURING SYSTEM AND METHOD FOR PROCESSING WORKPIECES

(71) Applicant: Aurora Flight Sciences Corporation, Manassas, VA (US)

(72) Inventors: James McDaniel Snider, II, Columbus, MS (US); Devin Richard Jensen, Belmont, MA (US); William Robert Bosworth, Cambridge, MA (US); Timothy Holifield, Starkville, MS (US)

(21) Appl. No.: 17/643,296

(22) Filed: Dec. 8, 2021

Related U.S. Application Data
(60) Provisional application No. 63/127,128, filed on Dec. 17, 2020.

(51) Int. Cl. B23Q 7/14; B23Q 3/08

(52) U.S. Cl. CPC B23Q 7/1426; B23Q 2703/04; B23Q 3/088

(57) ABSTRACT

A manufacturing system for processing workpieces includes a manufacturing cell, a plurality of pallets supporting workpieces, and at least one robotic device configured to operate on the workpieces. The manufacturing system also includes first and second processing stations configured to support any one of the pallets in fixed position relative to the robotic device. The manufacturing system additionally includes at least one transport device configured to transport any one of the pallets to and from each of the first and the second processing stations. In addition, the manufacturing system includes a controller configured to coordinate the operation of the manufacturing cell in a manner allowing the robotic device to continuously operate on a workpiece supported by a pallet at the first processing station, while another pallet is transported to or from the second processing station.

### CROSS-REFERENCE TO RELATED APPLICATION

This nonprovisional application claims priority to pending U.S. Provisional Application Ser. No. 63/127,128, entitled MANUFACTURING SYSTEM AND METHOD FOR PROCESSING WORKPIECES, filed Dec. 17, 2020, and which is incorporated herein by reference in its entirety.

### FIELD

The present disclosure relates generally to manufacturing systems and, more particularly, to an automated manufacturing system for processing workpieces.

### BACKGROUND

Robotic devices are increasingly incorporated into manufacturing facilities to perform tasks previously performed by humans. The use of robotic devices reduces labor costs, and allows for an increase in production throughput of the manufacturing facility. Examples of manufacturing operations performed by robotic devices include machining of workpieces, inspection of workpieces, and other types of operations. Workpieces may be manually loaded onto a station next to a robotic device. When the robotic device completes an operation on the workpiece, the workpiece may be manually unloaded from the station, and replaced with another workpiece to be operated on by the robotic device.

Manufacturing facilities containing robotic devices typically include safety systems configured to stop movement of the robotic devices upon detecting the presence of a human within the work envelope of the robotic devices. In addition, when a workpiece is manually loaded or unloaded from a station at a robotic device, the movement of the robotic device is temporarily stopped until the human moves out of the robot work envelope. As may be appreciated, the periods of time when robotic devices are non-operational reduces the production throughput of the manufacturing facility.

As can be seen, there exists a need in the art for a manufacturing system that avoids periods of non-operation of robotic devices otherwise occurring during changeout of workpieces.

### SUMMARY

The above-noted needs associated with manufacturing systems are specifically addressed and alleviated by the present disclosure which provides a manufacturing system for processing workpieces. The manufacturing system includes a manufacturing cell, a plurality of pallets each configured to support one or more workpieces, and at least one robotic device mounted in the manufacturing cell and configured to operate on the one or more workpieces. In addition, the manufacturing system includes at least two processing stations, including a first processing station and a second processing station, each located in the manufacturing cell and each configured to support any one of the plurality of pallets in fixed position relative to the robotic device. Furthermore, the manufacturing system includes at least one transport device configured to transport any one of the pallets to and from each of the first processing station and the second processing station. Additionally, the manufacturing system includes a controller configured to coordinate the operation of the manufacturing cell in a manner allowing the robotic device to continuously operate on a workpiece supported by one of the plurality of pallets at the first processing station while another one of the plurality of pallets is transferred to or from the second processing station.

Also disclosed is a manufacturing cell having a robotic device, a first processing station and a second processing station, and a controller. The robotic device is configured to operate on one or more workpieces each supported on a pallet. Each pallet is configured to be transported by a transport device. The first processing station and the second processing station are located within reach of the robotic device and are each configured to support a pallet in fixed position relative to the robotic device. The controller is configured to coordinate the operation of the manufacturing cell in a manner allowing the robotic device to continuously operate on a workpiece supported by a pallet at the first processing station while another pallet is transferred to or from the second processing station.

In addition, disclosed is a method of processing workpieces. The method includes supporting one or more workpieces on each of a plurality of pallets, and transporting, using a transport device, any one of the plurality of pallets onto a first processing station located in a manufacturing cell within reach of a robotic device. In addition, the method includes operating, using the robotic device, on a workpiece supported by one of the plurality of pallets at the first processing station while another one of the plurality of pallets is transferred to or from a second processing station located within reach of the robotic device.

The features, functions and advantages that have been discussed can be achieved independently in various examples of the present disclosure or may be combined in yet other examples, further details of which can be seen with reference to the following description and drawings below.

### BRIEF DESCRIPTION OF THE DRAWINGS

These and other features of the present disclosure will become more apparent upon reference to the drawings wherein like numbers refer to like parts throughout and wherein:

FIG. 1 is a perspective view of an example of a manufacturing cell for processing workpieces, and having several subcells including a machining subcell, an inspection subcell, and a cleaning subcell, and further illustrating a plurality of pallet stations each configured to support a pallet, with each pallet configured to support one or more workpieces;

FIG. 2 is a plan view of a manufacturing cell illustrating robotic devices mounted within the machining subcell and the inspection subcell, and further illustrating each robotic device having two pallet stations, and also illustrating transport devices for transporting pallets of workpieces to and from the pallet stations;

FIG. 2A is a plan view of an example of a manufacturing cell in which the transport devices comprise a conveyor system having a plurality of conveyor sections for transporting the pallets between the plurality of pallet stations;

FIG. 3 is a perspective view of an example of a transport device transporting a pallet and approaching an entrance to the machining subcell;

FIG. 4 is a perspective view of the example of the machining subcell of FIG. 3 with the roof removed to illustrate a pair of robotic devices mounted within the machining subcell, and illustrating a pair of pallet stations located proximate each robotic device;

FIG. 4A is a further example of the machining subcell illustrating the conveyor system for placing the pallets at the pallet stations proximate the robotic devices;

FIG. 4B is a sectional view taken along line 4B-4B of FIG. 4A, and illustrating an example of the conveyor system supporting a pallet at one of the processing stations, and further illustrating an example of a three-point locating system for lifting the pallet off of the conveyor system in preparation for the robotic device operating on the workpiece;

FIG. 4C is a sectional view taken along line 4C-4C of FIG. 4A, and illustrating a three-point locating system lifting the pallet off of the conveyor system and precisely positioning and orienting the pallet relative to the robotic device;

FIG. 5 is a plan view of the machining subcell illustrating an example of an intracell-mounted reference system for establishing the position of the robotic devices and the pallet stations within the machining subcell;

FIG. 5A is a plan view of the example of the machining subcell of FIG. 4A showing the conveyor system for placing the pallets at the pallet stations proximate the robotic devices;

FIG. 6 is a perspective view of an example of a robotic device in the machining subcell operating on a workpiece supported on a pallet mounted on a station frame at one of the pallet stations located proximate the robotic device;

FIG. 7 is a perspective view of an example of a pallet supporting a single workpiece;

FIG. 8 is a perspective view of an example of a pallet supporting a pair of workpieces;

FIG. 9 is a perspective view of an example of a pallet supporting four workpieces, with two of the workpieces having a different configuration than the other two workpieces;

FIG. 10 is a perspective view of an example of a transport device having a pair of forks which are shown inserted into a pair of fork tubes of a pallet while the pallet is mounted on a station frame at one of the pallet stations;

FIG. 11 is an exploded perspective view of an example of a three-point locating system configured for accurately locating a station frame on the floor of the manufacturing system at one of the pallet stations;

FIG. 12 is a perspective view of the three-point locating system of FIG. 11, and illustrating a cone system of the three-point locating system, wherein the cone system includes a primary locating cone, a secondary locating cone, and a rest button each removably coupled to an embedded plate bonded within a cored hole formed in the floor of the manufacturing cell;

FIG. 13 is a perspective view of a station frame having a cup system of the three-point locating system, wherein the cup system includes a primary locating cup, a secondary locating cup, and a flat pad configured to engage respectively with the primary locating cone, the secondary locating cone, and the flat pad of the cone system that is engaged to the floor as shown in FIG. 12;

FIG. 14 is a perspective view of a pallet mounted to the station frame of FIG. 13, wherein the pallet includes a cup system which is mounted on a cone system of the station frame of FIG. 13;

FIG. 15 is a perspective view of an example of a station frame mounted to a pallet station via a three-point locating system, and further showing a cup system mounted on an upper side of the station frame;

FIG. 16 is a magnified view of a portion of the station frame taken along line 16 of FIG. 15, and illustrating a station vacuum cone and an radio frequency identification (RFID) read/write head mounted to the station frame;

FIG. 17 is a magnified view of a portion of a pallet mounted on a station frame and taken along line 17 of FIG. 14, and illustrating the RFID read/write head of the station frame, and an RFID tag of the pallet;

FIG. 18 is a perspective view of an underside of an example of a pallet illustrating the cup system, and having a pair of pallet vacuum cups also mounted to the underside of the pallet;

FIG. 19 is a plan view of the underside of the pallet of FIG. 18 illustrating the cup system, the pallet vacuum cups, and further illustrating a vacuum reserve tank and a vacuum manifold;

FIG. 20 is a perspective view of a portion of the pallet of FIG. 19 illustrating a plurality of vacuum conduits coupling the vacuum manifold respectively to the pair of pallet vacuum cups, and to the vacuum reserve tank;

FIG. 21 is a sectional view taken along line 21-21 of FIG. 14, and illustrating an example of the primary or secondary locating cup of each of the pallet and the station frame mounted on the primary or secondary locating cone of each of the pallet station and floor of the manufacturing cell;

FIG. 22 is a sectional view taken along line 22-22 of FIG. 14, and illustrating an example of the flat pad of each of the pallet and the station frame mounted on the rest button of each of the pallet station and the floor of the manufacturing cell;

FIG. 23 is a sectional view of a pallet being lowered onto a station frame, and illustrating the primary locating cup of the pallet engaging a side of the primary locating cone of the station frame, and further illustrating the pallet vacuum cups laterally offset from other;

FIG. 24 is a sectional view of the pallet of FIG. 23 further lowered onto the station frame, and illustrating the engagement of the primary locating cup of the pallet with the primary locating cone of the station frame;

FIG. 25 is a sectional view of the pallet of FIG. 24 completely lowered onto the station frame, and illustrating the full engagement of the primary locating cup of the pallet with the primary locating cone of the station frame, and further illustrating the coupling of one of the pallet vacuum cups with the station vacuum cone;

FIG. 26 is a sectional view taken along line 26 of FIG. 24, and illustrating one of the pallet vacuum cups laterally offset from the station vacuum cone during the process of lowering the pallet onto the station frame;

FIG. 27 is a sectional view taken along line 27 of FIG. 25, and illustrating the pallet completely lowered onto the station frame, and further illustrating the pallet vacuum cup fully engaged with the station vacuum cone;

FIG. 28 is a side view of an example of a transport device transporting a pallet;

FIG. 29 is a magnified view of the portion of FIG. 28 identified by reference number 29, and illustrating a transport device vacuum pump fluidly coupled to a transport device vacuum cone, which is coupled to one of the pallet vacuum cup mounted on the underside of the pallet;

FIG. 30 is a sectional view of a pallet during the initial stage of being lowered by a transport device onto a station frame, and illustrating one of the pallet vacuum cups of the pallet engaged to the transport device vacuum cone of the transport device, while the other pallet vacuum cup of the pallet is vertically separated from the station vacuum cone of the station frame;

FIG. 31 is a sectional view of the pallet further lowered onto the station frame, and illustrating the pallet vacuum cup of the pallet still engaged to the transport device vacuum cone of the transport device, and further illustrating other the pallet vacuum cup of the pallet engaged to the station vacuum cone of the station frame;

FIG. 32 is a section view the pallet completely lowered onto the station frame, and illustrating one of the pallet vacuum cups of the pallet disengaged from the transport device vacuum cone of the transport device, while the other pallet vacuum cup of the pallet remains engaged to the station vacuum cone;

FIG. 33 is a perspective view of a transport device approaching a cell door of the machining subcell, and further illustrating a pass-through sensor mounted on a wall of the machining subcell;

FIG. 34 is a side view of the transport device approaching the subcell door of the machining subcell;

FIG. 35 is a flowchart of a method of processing workpieces.

### DETAILED DESCRIPTION

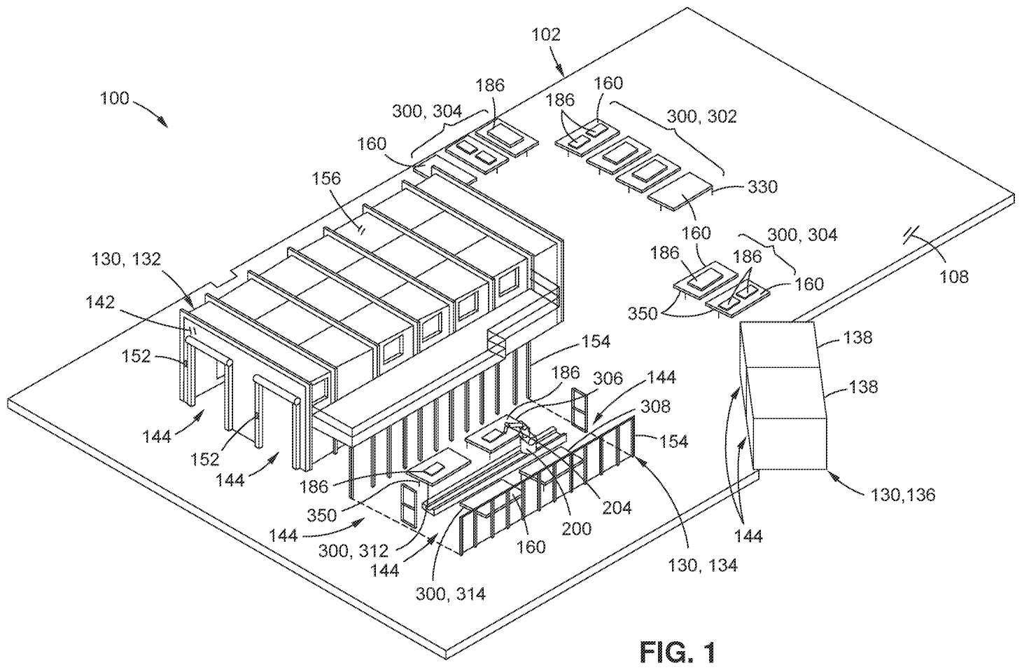

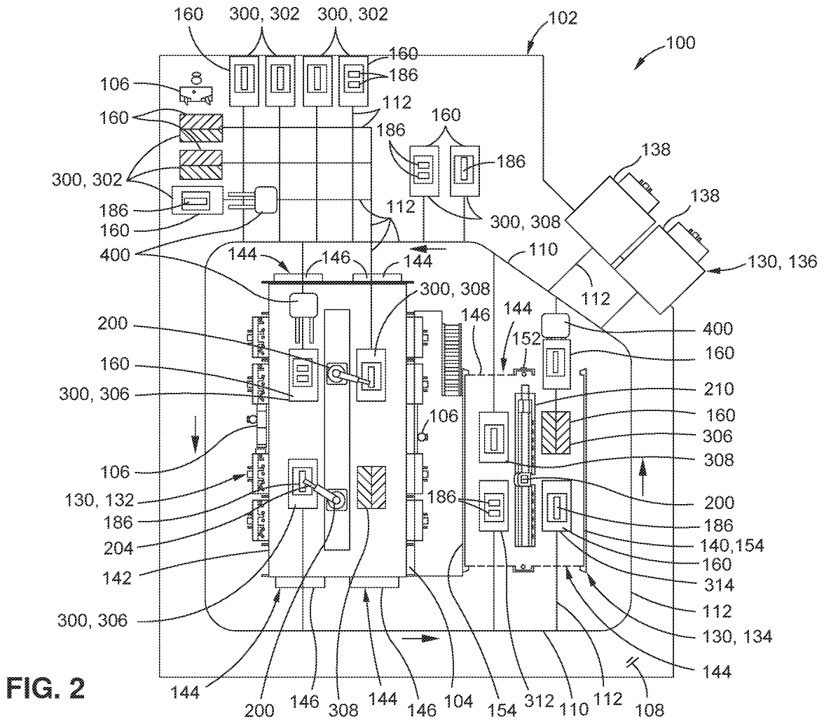

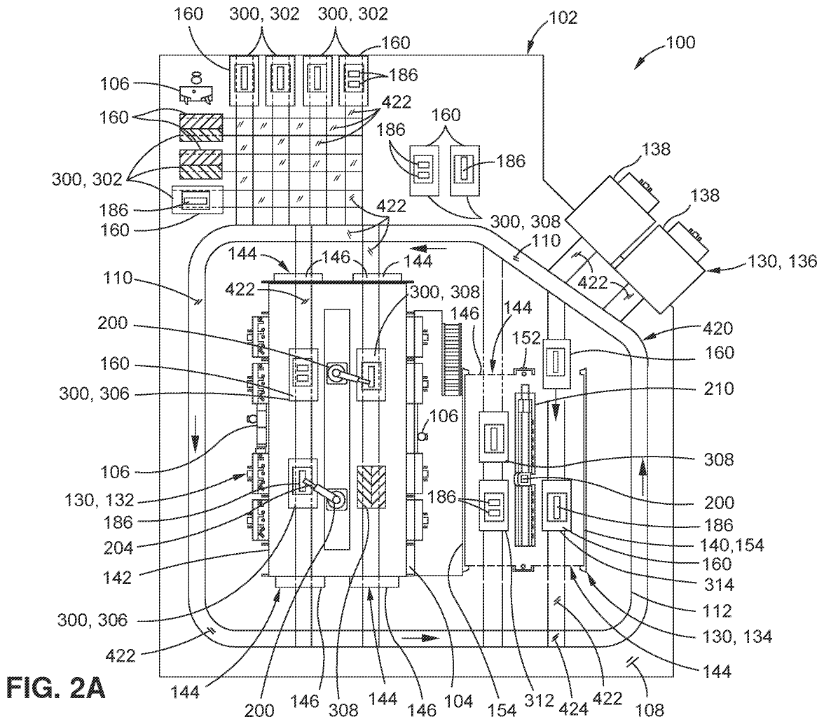

Referring now to the drawings which illustrate preferred and various examples of the disclosure, shown in FIGS. 1-2 are examples of a manufacturing system 100 for automated processing of workpieces 186. The manufacturing system 100 includes a manufacturing cell 102, which may be part of a manufacturing facility or factory. The manufacturing system 100 includes a plurality of pallets 160, and at least one robotic device 200 mounted in the manufacturing cell 102. Each one of the pallets 160 is configured to support one or more workpieces 186. Each robotic device 200 is configured to operate on the workpieces 186. In some examples, each robotic device 200 includes at least one robotic arm 204.

The manufacturing system 100 includes a plurality of pallet stations 300. The pallet stations 300 include at least two processing stations for each robotic device 200. For example, for each one of the robotic devices 200, the manufacturing system 100 includes a first processing station 306 and a second processing station 308 located in the manufacturing cell 102. The first processing station 306 and the second processing station 308 are each configured to support any one of the pallets 160 in fixed position relative to the robotic device 200 to allow the robotic device 200 to operate on one or more workpieces 186 supported on the pallet 160.

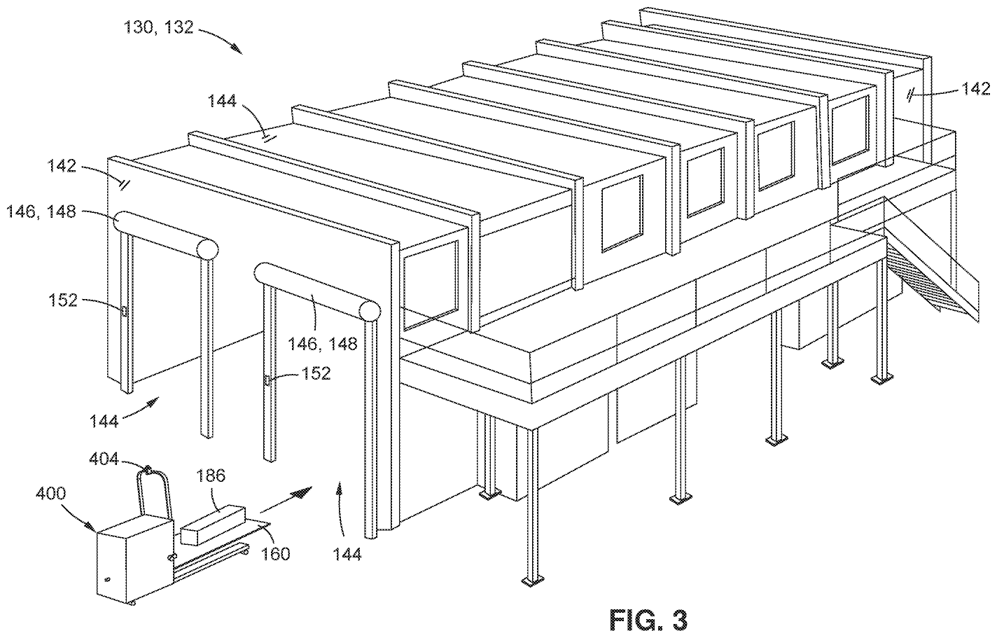

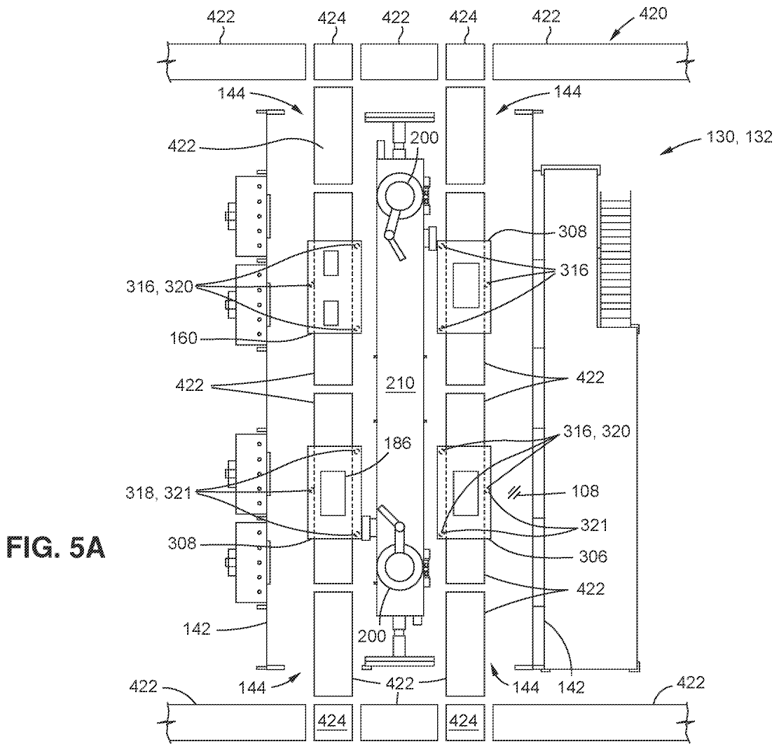

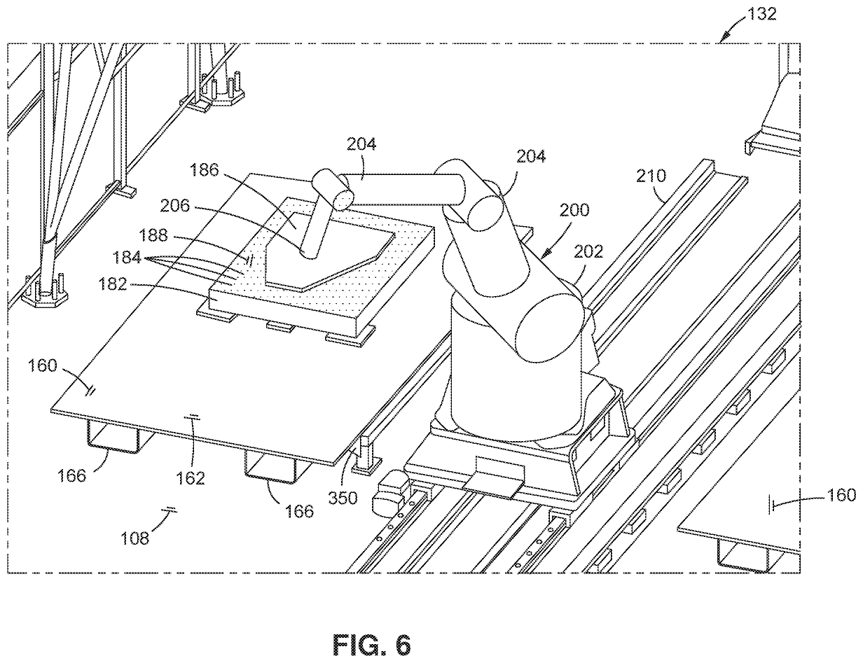

As shown in FIGS. 2-3, the manufacturing system 100 includes at least one transport device 400 configured to autonomously (i.e., without human intervention) transport any one of the pallets 160 to and from the first processing station 306 and the second processing station 308. In addition, the transport devices 400 transport pallets 160 to and from any one of the other pallet stations 300 in the manufacturing cell 102. As shown in FIG. 2, the manufacturing system 100 further includes a controller 104 (i.e., a processor) configured to coordinate the operation of the manufacturing cell 102 in a manner allowing the robotic device 200 to continuously operate on a workpiece 186 supported by one of the pallets 160 at the first processing station 306 while another one of the pallets 160 is transferred to or from the second processing station 308. In this regard, the controller 104 is configured to coordinate the operation of each transport device 400 and each robotic device 200 in a manner allowing each robotic device 200 to continuously operate on a workpiece 186 supported by a pallet 160 at a first processing station 306 of a robotic device 200, while the transport device 400 transfers another pallet 160 to or from the second processing station 308 of the same robotic device 200. In this regard, the robotic arms 204 of a robotic device 200 may continue to move and/or the end effector 206 (FIG. 6) of the robotic device 200 may continue to operate on a workpiece 186 at the first processing station 306 while a transport device 400 transports a pallet 160 to or from the second processing station 308. However, in other examples not shown, one or more of the pallet stations 300 may include at least one processing station for each robotic device 200, and the controller 104 may coordinate the operation of the robotic device 200 and the transport device 400 to allow the robotic device 200 to operate on a workpiece 186 supported on a pallet 160 at a processing station while the transport device 400 is in close proximity to the same processing station.

As shown in FIGS. 1-2A, the pallet stations 300 may include one or more feed stations 302 and/or one or more buffer queuing stations 304 or locations. Each of the feed stations 302 is configured to support a pallet 160 prior to transporting or movement by a transport device 400 to a processing station for being operated on by a robotic device 200 in accordance with predetermined processing operations defined for the workpieces 186 on the pallet 160. After the manufacturing cell 102 has completed all processing operations defined for the workpiece 186 on the pallet 160, a transport device 400 may return the pallet 160 to one of the feed stations 302, after which the pallet 160 is removed (e.g., manually, via forklift or crane—not shown) from the feed station 302 and placed into storage or transported to another manufacturing cell for further processing. The manufacturing cell 102 may also include one or more buffer queuing stations 304 or locations, as mentioned above. Each buffer queuing station 304 may temporarily support any one of the pallets 160 in between processing operations defined for the workpieces 186 on the pallet 160. The manufacturing cell 102 may also include one or more operator stations 106 (e.g., a desk) for occupation by personnel such as a production monitor or a supervisor for monitoring the operation of the manufacturing system 100.

Advantageously, the autonomous operation of the robotic devices 200 in coordination with the transportation of the pallets 160 via the transport devices 400 avoids periods of non-operation of the robotic devices 200 that would otherwise occur if the workpieces 186 were manually loaded and unloaded at the processing stations of each robotic device 200. As a result of the continuous operation of the robotic devices 200, the manufacturing system 100 results in an increase in the speed at which workpieces 186 move through the manufacturing cell 102, which results in an increase in production throughput of the manufacturing cell 102 relative to the throughput of a conventional manufacturing system that relies on manual labor for transporting and/or processing workpieces 186. In addition, the presently-disclosed manufacturing system 100 significantly reduces labor costs relative to the labor costs associated with conventional manufacturing systems.

Referring to FIGS. 1-6, the manufacturing cell 102 may include one or more subcells 130 for performing any one of a variety of different processes on the workpieces 186. In the example shown in the figures, the manufacturing cell 102 includes a machining subcell 132, an inspection subcell 134, and a cleaning subcell 136. Any one or more of the subcells 130 in the manufacturing cell 102 may include one or more robotic devices 200 for autonomously performing operations on workpieces 186. For example, the machining subcell 132 may include one or more robotic devices 200 configured for machining, trimming, drilling, sanding, additive manufacturing (e.g., additive printing), or performing any one of a variety of other types of operations. The inspection subcell 134 may include one or more robotic devices 200 for inspecting the dimensions of a workpiece 186, such as after machining and/or cleaning of the workpiece 186. In one example, the end effector 206 on the robotic device 200 in the inspection subcell 134 is an inspection laser scanner (not shown) for measuring the length, width, hole diameter, shape, surface contour, feature spatial position (e.g., in three-dimensional space), and/or other geometrical features of a workpiece 186. Although the presently-disclosed manufacturing system 100 is described in the context of a machining subcell 132, an inspection subcell 134, and a cleaning subcell 136, the manufacturing cell 102 may include any one of a variety of different subcells 130, and is not limited to the subcells 130 shown in the figures.

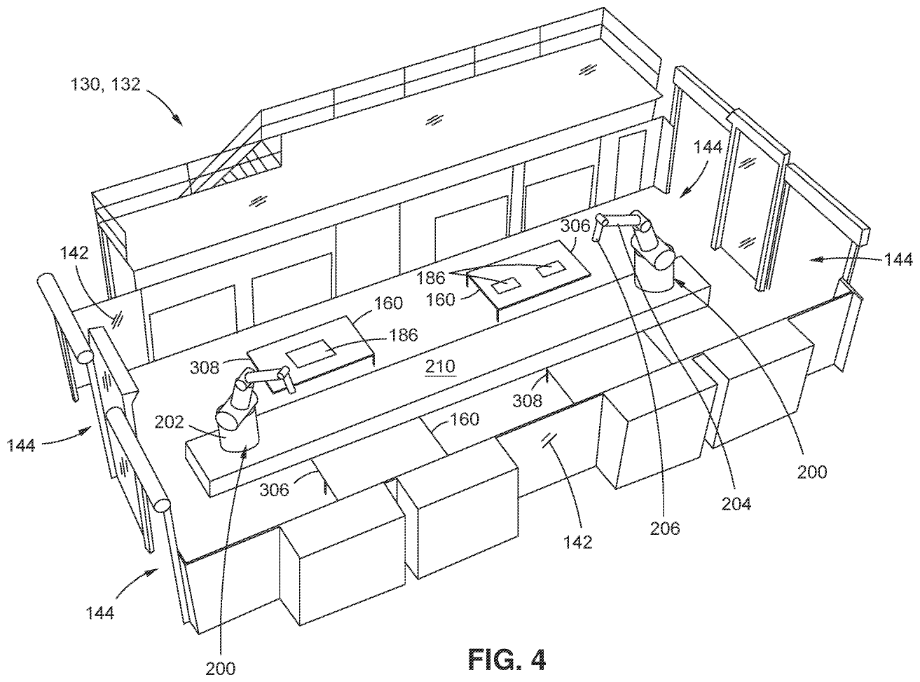

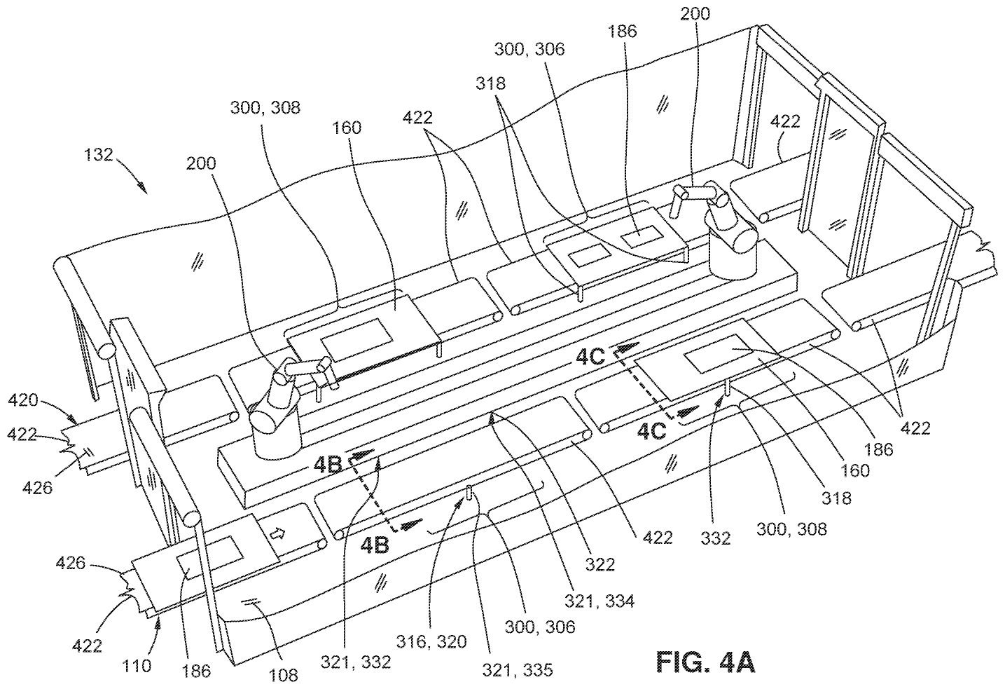

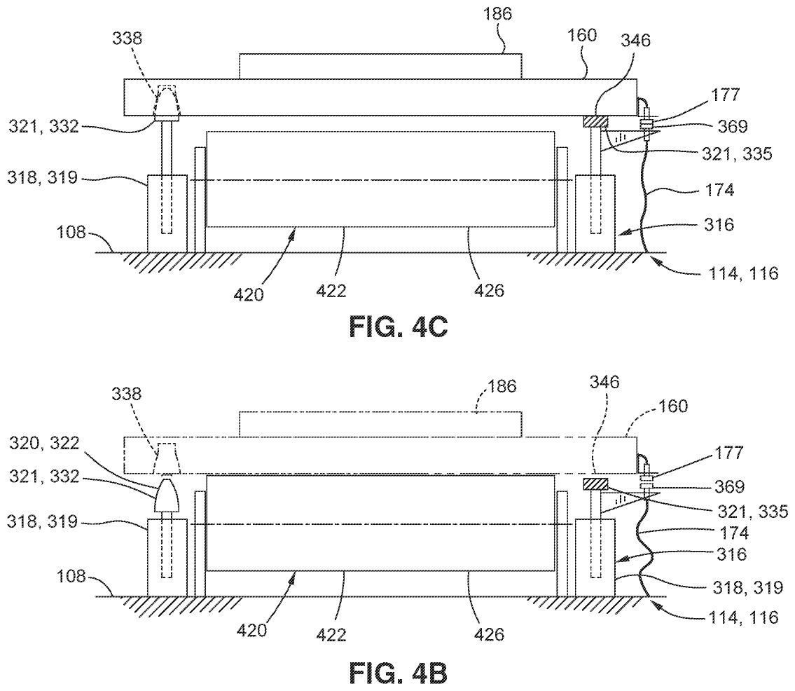

As mentioned above, the manufacturing system 100 includes one or more robotic devices 200 configured to operate on workpieces 186 when mounted at pallets 160 installed at one of the processing stations. For example, the machining subcell 132 may include a pair of robotic devices 200. In the present disclosure, a robotic device 200 may be described as any device, machine, assembly, system, subsystem, and/or any type of automated or semi-automated equipment capable of autonomously performing one or more operations on a workpiece. In this regard, a robotic device 200 is not limited to devices having one or more robotic arms 204. In the example shown, each of the robotic devices 200 may optionally be mounted on a linear rail system 210 (e.g., FIG. 4) to allow the robotic devices 200 to move in a longitudinal direction for expanding the work envelope of each robotic device 200. In some examples, the robotic device 200 may have a rotatable robotic base 202.

As shown in FIG. 6, each robotic device 200 may have at least one robotic arm 204 having an end effector 206 mounted on a distal end of the robotic arm 204. The end effector 206 is configured as any one of a variety of different types of processing tools. For example, the end effector 206 may be configured as a machining spindle which holds machining tools. However, in other examples, a robotic device 200 may include an end effector 206 configured as a forming tool, an additive manufacturing head (e.g., a three-dimensional printing head), a lamination head for laminating composite material onto a layup tool, a coating applicator for applying a coating to a workpiece 186, or other end effector configurations. For the inspection subcell 134, the end effector 206 of the robotic device 200 may be a laser inspection device. In another example, the end effector 206 may be an ultrasonic device for scanning composite workpieces 186 for internal conditions such as voids. As may be appreciated, the end effector 206 of the robotic device 200 in the inspection subcell 134 may be provided in any one of a variety of configurations for inspecting a workpiece 186.

The robotic devices 200 of the manufacturing cell 102 may have relatively high degrees-of-freedom to allow the robotic devices 200 to operate on a wide variety of workpieces 186 of different sizes, shapes, materials, and configurations. In addition, one or more of the robotic devices 200 may have an automated tool changer (not shown), providing the capability for autonomous (i.e., without human intervention) changeout of tools (not shown) used by an end effector 206 while one or more transport devices 400 are loading or unloading pallets 160 at the first processing station 306 and/or the second processing station 308. In this regard, autonomous changeout of the end effector 206 tools may allow the robotic devices 200 to perform a wide variety of operations on a workpiece 186. For example, a robotic device 200 may perform an additive manufacturing operation to add material to a workpiece 186, and then autonomously change out the end effector 206 tool to enable the robotic device 200 to perform drilling operations on the same workpiece 186 or on a different workpiece 186. Advantageously, the increased operational flexibility of the robotic devices 200 due to autonomous end effector 206 tool changeouts may reduce the amount of factory floor space required for production equipment, relative to the amount of floor space required to support a plurality of different types of production equipment (e.g., a conventional milling machine, an additive manufacturing machine) required to perform the same operations using a single robotic device 200.

As mentioned above, the manufacturing system 100 includes at least two processing stations, including a first processing station 306 and a second processing station 308, dedicated to each robotic device 200 and configured to support a pallet 160 within reach of the robotic device 200. In the example manufacturing cell 102 shown in FIGS. 2-5, the machining subcell 132 includes two robotic devices 200, each having a first processing station 306 and a second processing station 308. The first processing station 306 may support a pallet 160 of workpieces 186 being operated on by the robotic device 200, while the second processing station 308 supports a pallet 160 of workpieces 186 that have been operated on by the robotic device 200, and which are awaiting a transport device 400 to transport the pallet 160 to the next pallet station 300. In the machining subcell 132 arrangement shown in FIGS. 2-5, the two robotic devices 200 is configured to work collaboratively on workpieces 186 that exceed the size of a single pallet 160. For example, two processing stations on one side of the linear rail system 210 may collectively support a single workpiece 186 while both of the robotic devices 200 operate on the workpiece 186. Operation of the robotic devices 200 in the machining subcell 132 may be monitored and/or at least partially controlled by a human operator located at an operator station 106 where the operator has a view of the robotic devices 200.

Referring still to FIGS. 1-5A, the machining subcell 132 may be enclosed by subcell walls 142 and a subcell roof 156 for controlling dust and preventing uncontrolled human entry. The machining subcell 132 may include at least one entrance 144 for passage of transport devices 400 into and out of the machining subcell 132. As described in greater detail below, each entrance 144 may have at least one pass-through sensor 152 and an entrance barrier 146 (e.g., a subcell door 148) that is selectively configurable (i.e., openable and closable) to allow passage (i.e., entry or exit) of the transport device 400 through the entrance 144 upon detection of the transport device 400 at the entrance 144, without triggering an emergency stop of the robotic devices 200 in the machining subcell 132. The machining subcell 132 may also include a separate man-door (not shown) to allow human access into the machining subcell 132. The machining subcell 132 may include a dust-management system (not shown) for maintaining a clean working environment and reducing the negative impact of dust accumulation on the robotic devices 200 and other components and workpieces 186 in the machining subcell 132. For example, the machining subcell 132 may include a dust collection booth (not shown) for collecting dust generated during machining, trimming, drilling, and/or sanding of workpieces 186.

In FIGS. 2-2A, the inspection subcell 134 is shown having a single robotic device 200 mounted on a linear rail system 210, and having an inspection laser scanner as the end effector 206. In addition, the inspection subcell 134 is shown having four (4) processing stations each located within reach of the robotic device 200, including a first, second, third, and fourth processing station 306, 308, 312, 314. Similar to the operation of the machining subcell 132, the robotic device 200 in the inspection subcell 134 is configured to inspect one or more workpieces 186 mounted on a pallet 160 located at one processing station, while one or more pallets 160 are respectively transported to or from one of the other processing stations in the inspection subcell 134. Similar to the machining subcell 132, the operation of the inspection subcell 134 is monitored and/or partially controlled by an operator at an operator station 106 providing a view of the robotic device 200. The inspection subcell 134 may be at least partially enclosed by a subcell boundary 140 which, in the example shown, may include a safety fence 154 on each of opposing sides of the inspection subcell 134. The opposing ends of the inspection subcell 134 may each be protected by an optical safety curtain (not shown) generated by one or more door laser scanners (not shown) sweeping a laser beam or curtain across the entrance 144 of the inspection subcell 134. Similar to the above-described operation of the machining subcell 132, the entrances 144 on the ends of the inspection subcell 134 may each include a pass-through sensor 152 that, when triggered (e.g., upon receiving a transport device signal), causes the controller 104 to allow a transport device 400 to enter the inspection subcell 134 without triggering an emergency stop of the robotic device 200.

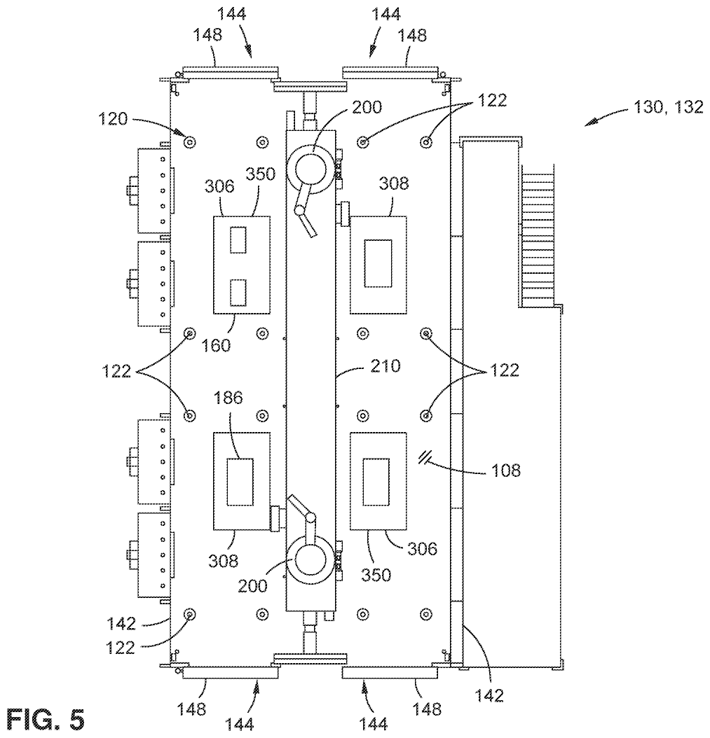

Referring briefly to FIG. 5, any one of the subcells 130 may include an intracell-mounted reference system 120 for establishing the positions of one or more objects within the subcell 130. The intracell-mounted reference system 120 may include a plurality of ball nests 122 embedded within the floor 108 or on the subcell walls 142, ceiling, or other monuments. Each ball nest 122 is configured to receive a spherical ball (not shown) to serve as a target for a laser system (not shown) for establishing or verifying the three-dimensional position of the objects (e.g., pallet stations 300, station frames 350, robotic devices 200—FIG. 6) in the subcell 130 (e.g., the machining subcell 132 and/or the inspection subcell 134). The intracell-mounted reference system 120 may be used if there have been recent major changes to the manufacturing cell 102, such as changes to the configuration of the subcell 130, or following the installation of new robotic devices 200, or if it is suspected that the position or orientation of the station frames 350 or robotic devices 200 may have been altered due to a recent seismic event, or due to contact of a transport device 400 with a station frame 350 or a robotic device 200 in the subcell 130.

In addition to subcells 130 having robotic devices 200, the manufacturing system 100 may include one or more subcells 130 that are operated by technicians (i.e., humans) instead of robotic devices 200. Each subcell 130 staffed by a technician may include one or more processing stations for supporting a pallet 160. For example, the cleaning subcell 136 in FIG. 2 has two cleaning booths 138 arranged side-by-side. However, in other examples, the manufacturing cell 102 may include cleaning booths 138 located in line and/or between robotic devices 200. Regardless of location, each cleaning booth 138 is staffed by a cleaning technician, and may include a single processing station for supporting a pallet 160 containing one or more workpieces 186 to be cleaned or washed by the cleaning technician. The cleaning subcell 136 is used for cleaning workpieces 186, such as after the workpieces 186 have been processed by the machining subcell 132, and prior to inspection of the workpieces 186 by the inspection subcell 134. The cleaning subcell 136 may include a dust control and collection system (not shown). In addition, each cleaning booth 138 may have access to a compressed air source to allow the cleaning technician to blow machining dust off of the pallets 160, workpieces 186, and workpiece mounting fixtures 182 (e.g., FIG. 6) that support the workpieces 186 on the pallets 160. The manufacturing cell 102 may also have subcells (not shown) to perform additional manual processes such as deburring of workpieces 186, visual inspection of workpieces 186, and other manual operations.

Referring to FIGS. 2-3, the manufacturing system 100 may include any number of transport devices 400. As mentioned above, each transport device 400 is configured to transport pallets 160 between processing stations. The transport devices 400 may be provided in any one of a variety of different configurations. For example, in FIG. 2, the transport devices 400 are provided as vehicles. In other examples not shown, the transport devices 400 are provided as overhead equipment such as cranes or gantries (not shown), or as drones (not shown). In a still further example shown in FIGS. 2A, 4A-4C and 5A, the transport devices 400 are provided as a plurality of floor-mounted conveyor sections 422 of a conveyor system 420, as described below. In one example, a transport device 400 may be described as a robotic vehicle programmed to autonomously navigate the manufacturing cell 102. A robotic vehicle (e.g., FIG. 2) may have a guidance system for navigating along predetermined transport device routes 110 between pallet stations 300.

In FIG. 2A, the conveyor system 420 (e.g., FIG. 2A) may have multiple conveyor sections 422 defining the transport devices routes 110 between the pallet stations 300. Each conveyor section 422 may includes a conveyor belt 426 (FIG. 4A) supported by a series of rollers (not shown). The rollers may be supported by a series of support posts (not shown) extending from the floor 108 on opposite sides of the conveyor belt 426. The conveyor system 420 may include a rotatable conveyor section 424 at each intersection of two conveyor sections 420 oriented in different directions. When a pallet 160 being transported along one conveyor section 422 arrives at a rotatable conveyor section 424, the rotatable conveyor section 424 rotates the pallet 160 to thereby orient the pallet 160 into alignment with the intersecting conveyor section 422 to allow the pallet 160 to move along the intersecting conveyor section 422. Alternatively or additionally, the conveyor system 420 may include a mechanical push mechanism (not shown) at each intersection, to push the pallets 160 from one conveyor section 422 onto an intersecting conveyor section 422.

The transport device routes 110 are made up of a plurality of route segments 112. The scheduling of the timing and order of movement of the transport devices 400 and/or the pallets 160 between pallet stations 300 is controlled by the controller 104 of the manufacturing system 100, and may be based on a time simulation of the flow of workpieces 186 through the manufacturing cell 102. The movement of individual transport devices 400 (e.g., FIG. 2) along the transport device routes 110, and/or the transportation of the pallets 160 along the transport device routes 110 via the conveyor system 420 (e.g., FIG. 2A), is controlled by a transport device software module.

In the example of FIG. 2, the movement of the pallets 160 via the transport devices 400 is programmed or controlled in a manner causing the transport devices 400 to travel along certain a known path or route segments 112 in a common (i.e., one-way) direction to avoid conflicts with the movement of other pallets 160 and/or other transport devices 400. The guidance system of transport devices 400 configured as vehicles may be a laser guidance system (not shown) having a laser device for tracking laser reflectors (not shown) mounted to the floor 108 and/or to other structures (e.g., subcell walls 142, manufacturing facility walls, etc.) of the manufacturing cell 102. In another example, the guidance system of the transport devices 400 may be a magnetic guidance system or a linear scale guidance system comprising sensors (not shown) on each transport device 400 for sensing magnetic elements or scale elements (e.g., magnetic tape, linear scale—not shown) mounted on or in the floor 108 of the manufacturing facility.

The transport devices 400 and/or the manufacturing cell 102 may include one or more safety systems configured to automatically halt the movement of a transport device 400 upon determining the potential for contact between the transport device 400 and an obstruction along a transport device 400 route. In some examples, each transport device 400, such as each robotic vehicle, may include a light imaging and ranging system (e.g., LIDAR) to avoid colliding with unexpected objects. The manufacturing cell 102 may include one or more idle stations (not shown) for temporarily parking a transport device 400 (i.e., vehicle) during the production of workpieces 186. The idle stations are strategically positioned within the manufacturing cell 102 to decrease the average time required for a transport device 400 to reach any pallet station 300. The idle stations are located off of the transport device routes 110 to avoid interfering with the movement of other transport devices 400. The idle stations may each include a charging system for recharging the batteries of the transport device 400 while parked at the idle station.

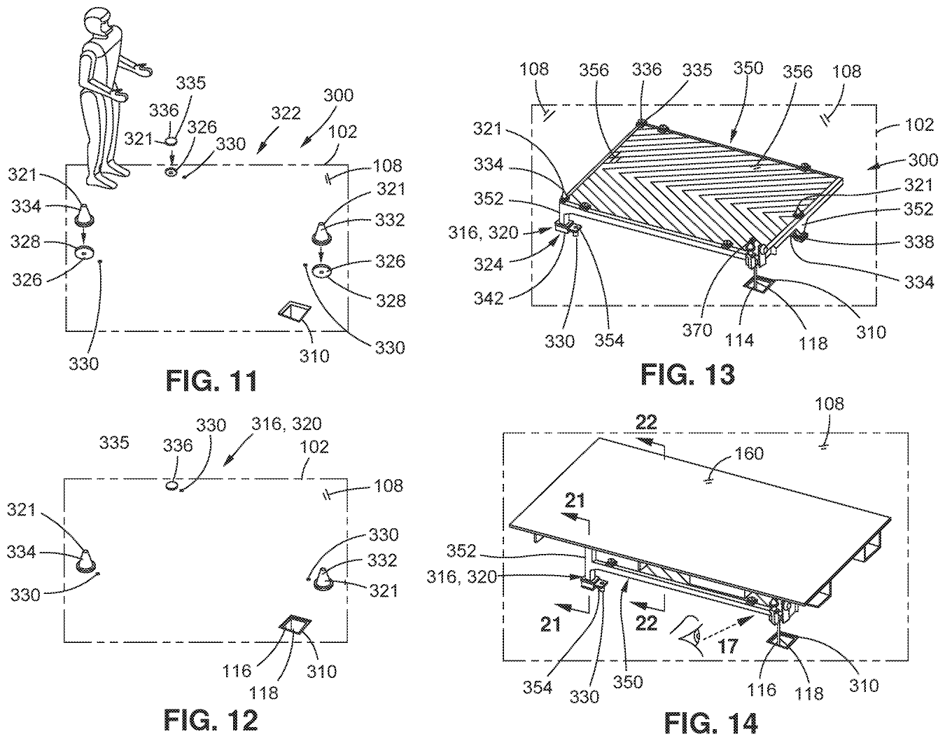

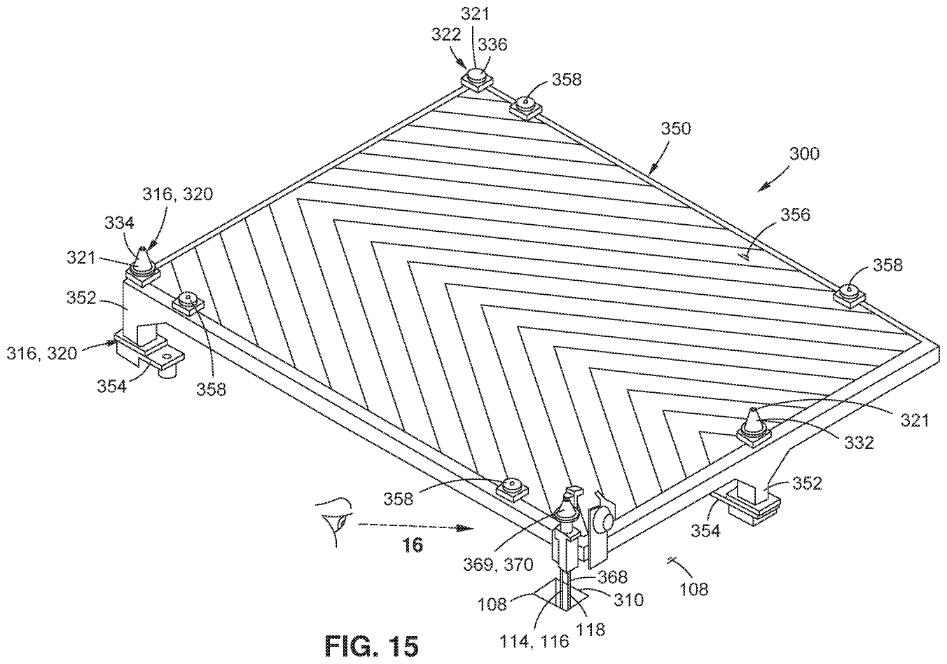

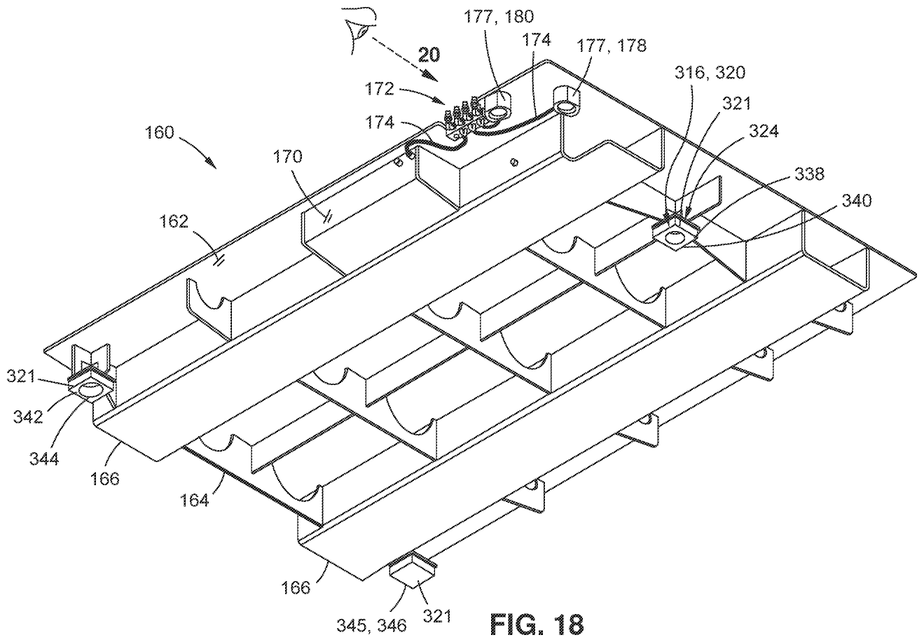

Referring to FIGS. 1, 4, 5 and 6, the manufacturing system 100, may include a station frame 350 at each pallet station 300. Each station frame 350 is removably mounted to the floor 108 of the manufacturing cell 102. As shown in FIGS. 11-16 and 18 and described in greater detail below, each station frame 350 is precisely and repeatably located and oriented at a pallet station 300 via a mechanical locating system 316 (FIG. 15) having multiple locating points 321 (FIG. 15) configured to precisely and repeatably locate the station frame 350 to the floor 108 of the manufacturing cell 102. Similarly, each pallet 160 is located and oriented on a station frame 350 via a mechanical locating system 316 (FIG. 18) having multiple locating points 321 (FIG. 18) configured to precisely and repeatably locate the pallet 160 to the station frame 350. In the example shown, each locating system 316 is a three-point locating system 320 having exactly three locating points 321. However, in other examples not shown, the locating system 316 may be a four-point locating system having four locating points 321 arranged in an orthogonal pattern, such as a rectangular pattern or a square pattern. Regardless of the number of locating points 321, the locating system 316, such as the three-point locating system 320 shown in FIGS. 11-16, is configured such that when a pallet 160 is loaded onto a station frame 350 at a processing station 306, 308, the one or more workpieces 186 (FIG. 6) on the pallet 160 (FIG. 6) are within the reach envelope of the end effector 206 (FIG. 6) of the robotic device 200 (FIG. 6) that the processing station 306, 308 is associated with.

For the manufacturing system 100 example of FIGS. 4A-4C in which the transport device 400 comprises a conveyor system 420, the pallet 160 at each processing station 306, 308 is located and oriented via a mechanical locating system 316. The mechanical locating system 316 at each processing station 306, 308 includes a plurality of locating points 321 321 for supporting the pallet 160. Once the conveyor system 420 transports a pallet 160 into one of the processing stations 306, 308 proximate a robotic device 200, the locating points 321 at the processing station 306, 308 are configured to lift the pallet 160 off of the conveyor belt 426, and non-movably support the pallet 160 a relatively short distance (e.g., up to 3 inches) above the conveyor belt 426 in a precise location and orientation relative to the robotic device 200, as described below.

As shown in FIGS. 4A-4C, the locating points 321 at each processing station 306, 308 may include a cone system 322, comprised of locating cones for lifting and supporting the pallet 160. For example, the locating system 316 at each processing station 306, 308 is a three-point locating system 320 having a primary locating cone 332 and a secondary locating cone 334, both of which may be located on one side of the conveyor section 422. The primary locating cone 332 and the secondary locating cone 334 are tapered. The three-point locating system 320 also includes a tertiary locating element 335 (e.g., a planar plate) located on an opposite side of the conveyor section 422 from the locating cones. The locating cones are configured similar to the locating cones described below and shown in FIGS. 15, 18, 19, and 21-25, and are also shaped complementary to the below-described locating cups of the cup system 324 included with the pallet 160. The primary locating cone 332, the secondary locating cone 334, and the tertiary locating element 335 may each be mounted on a locating point post 318 extending upwardly from the floor 108. Each locating point post 318 has a locating point actuator 319 (e.g., an electromechanical actuator, a pneumatic actuator, a hydraulic actuator, etc.), for vertically moving the primary locating cone 332, the secondary locating cone 334, and the tertiary locating element 335.

Referring to FIG. 4B, each pallet 160 is positioned on the conveyor system 420 such that when a pallet 160 arrives at one of the processing stations 306, 308 (e.g., FIG. 4A), the vertical centerlines (not shown) of the locating cups of the pallet 160 are generally aligned with the vertical centerlines (not shown) of the locating cones at the processing station 306, 308. For example, the vertical centerlines of the locating cups of the pallet 160 are within a relatively small distance (e.g., 0.5 inch) of the vertical centerlines of the locating cones.

Referring to FIG. 4C, with the pallet 160 stationary on the conveyor section 422 at the processing station 306, 308, the locating point actuators 319 are activated to move the primary locating cone 332, the secondary locating cone 334, and the tertiary locating element 335 upwardly into engagement respectively with the primary locating cup 337, the secondary locating cup 342, and the tertiary locating feature 345 (e.g., a planar underside) of the pallet 160. The engagement of the tapered shape of the locating cone with the tapered shape of the locating cups results in self-positioning of the pallet 160 (and workpiece 186) into a repeatable and precise location relative to the robotic device 200. The locating point actuators 319 may lift the pallet 160 off of the conveyor belt 426, and non-movably support the pallet 160 (and workpiece 186) in a precise and repeatable location and orientation relative to the robotic device 200.

In FIGS. 4B-4C, the upward movement of the cone system 322 at the processing station 306, 308 into engagement with the cup system 324 of the pallet 160 may also result in the engagement of a station vacuum connector 369 of the processing station 306, 308 with a pallet vacuum connector 177 of the pallet 160. The station vacuum connector 369 is fluidly coupled to a factory vacuum pressure source 116, such as a factory vacuum pump. When the station vacuum connector 369 is sealingly engaged with the pallet vacuum connector 177, the factory vacuum pressure source 116 may provide vacuum pressure at the apertures 184 (FIG. 6) of the mounting surface 188 of the workpiece mounting fixture 182 for vacuum coupling of the workpiece 186 to the workpiece mounting fixture 182 for when the workpiece 186 is operated on by the robotic device 200, as described below with regard to FIG. 6.

For the conveyor system 420 of FIGS. 2, 4A-4C and 5A, the locating system 316 may be omitted from processing stations 306, 308 that do not require precise location and/or precise orientation of the pallet 160 (and workpiece 186). For example, the locating system 316 may be omitted from processing stations 306, 308 that involve manual processes such as washing (e.g., at a cleaning subcell 136), deburring, visual inspection, and other workpiece operations. In addition, the locating system 316 may be omitted from pallet stations 300 such as feed stations 302 and buffer queuing stations 304 or locations. The pallets 160 at feed stations 302 and buffer queuing stations 304 may instead by supported on a conveyor section 422 dedicated to that pallet station 300.

Referring to FIG. 6, shown is an example of a manufacturing system 100 wherein each pallet 160 is mounted on a station frame 350 at a processing station 306, 308 near a robotic device 200. As mentioned above, in any of the manufacturing system 100 examples disclosed herein, the pallet 160 may have one or more workpiece mounting fixtures 182. Each workpiece mounting fixture 182 is configured to support one or more workpieces 186. Each workpiece mounting fixture 182 has a mounting surface 188. The contour of the mounting surface 188 is complementary to the contour of the workpiece 186 to be supported by the workpiece mounting fixture 182. The workpiece mounting fixture 182 may be permanently mounted to the pallet 160. For example, each workpiece mounting fixture 182 may be coupled to a pallet 160 via mechanical fasteners extending through one or more of a plurality of fastener holes (e.g., circular holes and/or slots—not shown) formed in a pallet base panel 162.

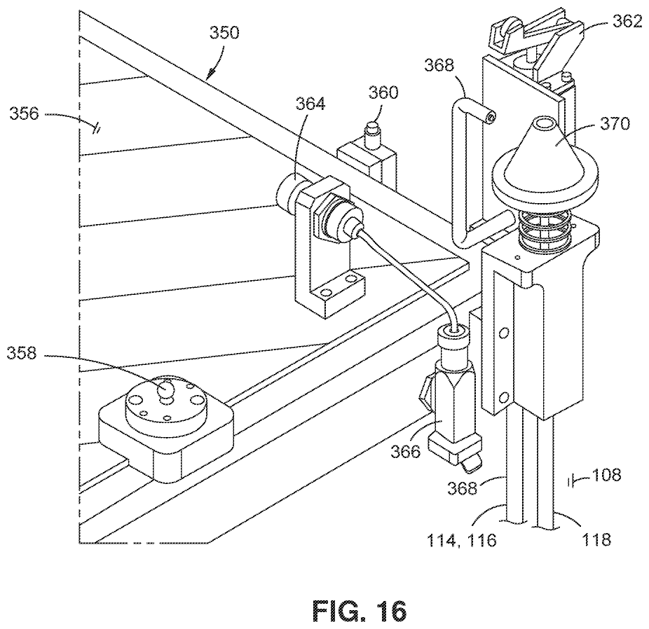

The mounting surface 188 of the workpiece mounting fixture 182 may contain a plurality of apertures 184. The apertures 184 of the workpiece mounting fixture 182 is fluidly coupled to a vacuum pressure source 114 (FIG. 16) via internal passages (not shown) in the workpiece mounting fixture 182. Vacuum pressure at the apertures 184 may result in vacuum coupling of the workpiece 186 to the mounting surface 188, and may prevent movement of the workpiece 186 relative to the pallet 160 when the workpiece 186 is being operated on by the robotic device 200. In addition, vacuum coupling of the workpiece 186 to the mounting surface 188 may prevent movement of the workpiece 186 relative to the pallet 160 when the pallet 160 is being transported by the transport device 400, as described below.

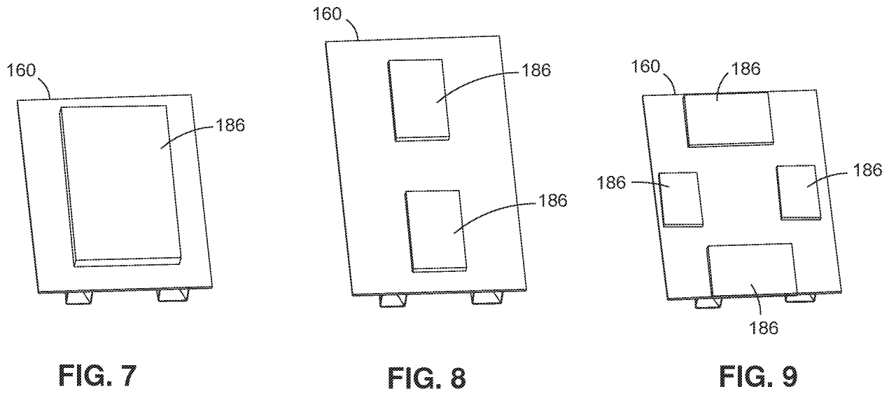

Referring to FIGS. 7-9, shown are examples of pallets 160 supporting different configurations of workpieces 186, with each workpiece 186 mounted on a workpiece mounting fixture 182 securely coupled to the pallet 160. The pallets 160 may be provided in one or more lengths based on the size and/or quantity of workpieces 186 to be supported by the pallet 160. For example, FIGS. 7 and 9 illustrate a pallet 160 having a standard size of 65 inches wide by 88 inches long. FIG. 7 shows the pallet 160 supporting a single workpiece 186. FIG. 9 shows the pallet 160 of the same size as in FIG. 7, and showing the pallet 160 supporting four workpieces 186 of relatively small size, with two of the workpieces 186 having a different configuration than the other two workpieces 186 on the pallet 160. FIG. 8 illustrates a pallet 160 having the same width as the pallets 160 of FIGS. 7 and 9, but having an extended length of 113 inches, and is shown supporting two workpieces 186 each having a relatively long length. As may be appreciated, the pallets may be provided in any one a variety of different sizes, shapes and configurations, and is not limited to the sizes and shapes disclosed herein.

As mentioned above, the manufacturing cell 102 is configured to process workpieces 186 of any size, shape, configuration, and material composition, including metallic workpieces 186 and/or non-metallic workpieces 186. For example, the workpieces 186 may be comprised of aluminum, steel, or any one of a variety of other metallic compositions. In another example, the workpieces 186 may be composite workpieces 186 comprised of fiber-reinforced polymer matrix material.

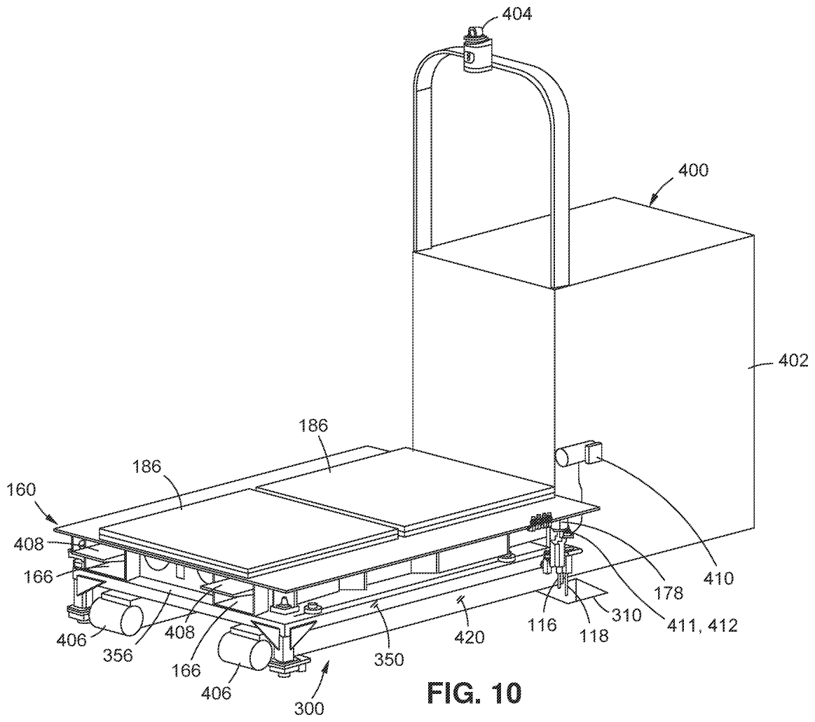

Referring to FIG. 10, shown is an example of a transport device 400 configured as a vehicle for transporting pallets 160 between the pallet stations 300 of the manufacturing cell 102. The transport device 400 may have a vehicle chassis 402 and vehicle wheels 406. In the example shown, the transport device 400 has a pair of vertically movable vehicle forks 408. The vehicle forks 408 is configurable for engagement with a corresponding pair of fork tubes 166 (FIG. 6) of each pallet 160 for raising and lowering the pallet 160 onto the pallet stations 300 of the manufacturing cell 102. The vehicle forks 408 are inserted into the fork tubes 166 of a pallet 160 while the pallet 160 is mounted on a station frame 350 at one of the pallet stations 300. The vehicle forks 408 are vertically movable for raising and lowering pallets 160 off of pallet stations 300. In an alternative example not shown, the transport device 400 is configured as a non-forked transport device having a relatively low profile, and may be configurable into a height that is shorter than the height of the station frame panel 356 above the floor 108 (FIG. 6). In such an arrangement, the station frame 350 is open at one end to allow the transport device 400 to move underneath the station frame panel 356 and underneath the pallet 160. Once the transport device 400 is underneath the pallet 160, the transport device 400 may raise upwardly into engagement with the bottom of the pallet 160 to lift the pallet 160 off the station frame 350. The transport device 400 may then translate the pallet 160 away from the station frame 350 and transport the pallet 160 to another pallet station 300.

As mentioned above, any transport device 400 vehicle disclosed herein may have a laser guidance system (not shown) having at least one vehicle signaling device 404 (e.g., a laser beacon) for emitting a laser beam for reflecting off of laser reflectors (not shown) mounted at different locations in the manufacturing cell 102. In addition, the laser beam emitted by the vehicle signaling device 404 is sensed by a pass-through sensor 152 (FIG. 3) located proximate an entrance 144 (FIG. 3) to a subcell 130 (FIG. 3) to trigger activation of the entrance barrier 146 (e.g., a subcell door 148—FIG. 3), thereby allowing the transport device 400 to pass through the entrance 144. In another example, the vehicle signaling device 404 may be a wireless transmitting device configured to transmit a wireless signal over a dedicated wifi network of the manufacturing cell 102. The wireless signal may include a request for opening the entrance 144. While the transport device 400 waits near the entrance 144, the controller 104 (FIG. 2), in response to the pass-through sensor 152 sensing or receiving the transport device signal, may determine whether or not to allow the transport device 400 to pass through the entrance 144, as described below. In addition to a vehicle signaling device 404, any one of the transport device 400 examples disclosed herein may also include a transport device vacuum source 410 (e.g., a vacuum pump) for generating vacuum pressure at the apertures 184 of the mounting surface 188 (FIG. 6) of the workpiece mounting fixture 182 (FIG. 6) for maintaining vacuum coupling of the workpiece 186 to the workpiece mounting fixture 182 when the pallet 160 is transported between pallet stations 300 by the transport device 400.

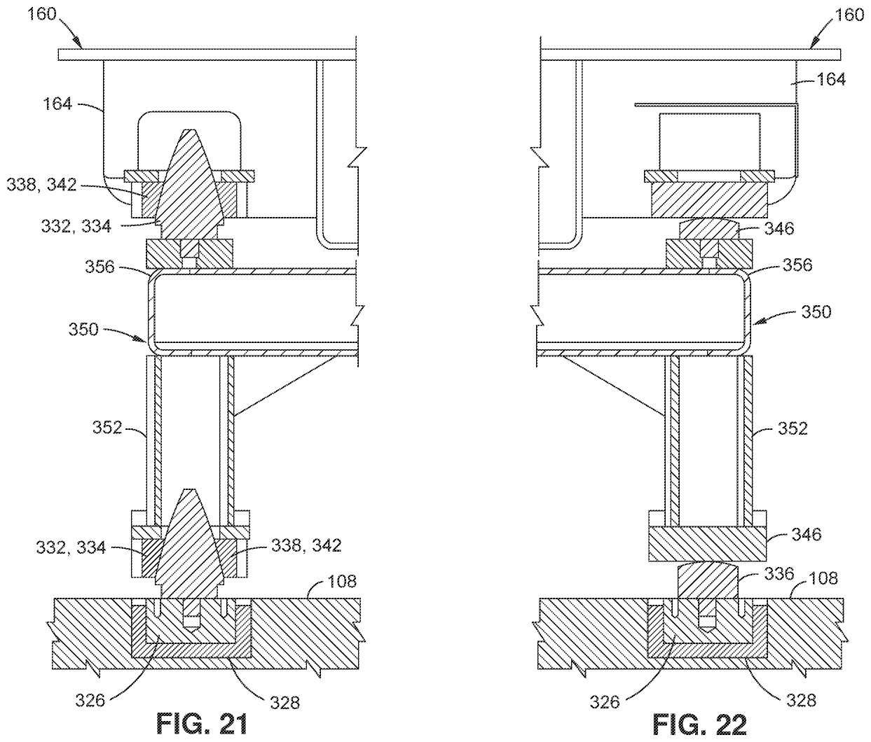

Referring to FIGS. 11-14, shown in FIG. 11 is an exploded view of example of a cone system 322 that is mountable to the floor 108 of the manufacturing cell 102. The cone system 322 is part of a locating system 316 that contains exactly three locating points 321, including two locating cones 332, 334 and a tertiary locating element 335, arranged in a triangular pattern. However, the locating system 316 may includes more than three locating points 321. The locating cones of the cone system 322 include a primary locating cone 332, and a secondary locating cone 334. The tertiary locating element 335 is configured as a rest button 336 as shown. The primary locating cone 332, the secondary locating cone 334, and the tertiary locating element 335 (e.g., the rest button 336) may each be removably couplable to an embedded plate 326 (FIG. 21) that is bonded within a cored hole 328 (FIG. 21) formed in the floor 108 of the manufacturing cell 102. The primary locating cone 332 and the secondary locating cone 334 may each have a generally conical outer surface (e.g., a simple cone shape, an ogive shape, or other rounded conical shape—FIG. 21), and the rest button 336 may have at least a partial spherical outer surface (e.g., FIG. 22). The cone system 322 is part of a three-point locating system 320 for accurately and repeatably locating and orienting a station frame 350 on the floor 108 of the manufacturing system 100 at one of the pallet stations 300.

FIG. 12 shows the primary locating cone 332, the secondary locating cone 334, and the rest button 336 threadably engaged respectively to the embedded plates 326 in the floor 108. Also shown in FIGS. 11 and 12 is a utilities pit 310 through which the pallet station 300 and/or the station frame 350 may have access to various utilities, such as a factory vacuum pressure source 116, a factory compressed air source 118, controller input/output lines, and/or electrical power. In some examples of the manufacturing cell 102, each one of the pallet stations 300, including the first and second processing stations 306, 308 (FIGS. 1-2), the feed stations 302 (FIGS. 1-2, and the buffer queuing stations 304 (FIGS. 1-2, may include a cone system 322 to engage with the cup system 324 of any one of the pallets 160, to thereby enable any pallet 160 to be precisely located relative to the floor 108 the manufacturing cell 102. In other examples of the manufacturing cell 102, only the processing stations 306, 308 near robotic devices 200 may have a cone system 322, and the remaining pallet stations 300 may be devoid of a cone system 322.

FIG. 13 shows an example of a station frame 350 mounted to the floor 108 of the manufacturing cell 102 via a cup system 324 (FIG. 18). In the example, shown, the station frame 350 includes three station frame legs 352 extending downwardly from a station frame panel 356. The cup system 324 of the station frame 350 is similar to the cup system 324 of the pallet 160. The cup system 324 includes two locating cups 338, 342 (FIG. 18) and a tertiary locating feature 345 (FIG. 18) arranged in a triangular pattern that is complementary to the triangular pattern of the cone system 322. The tertiary locating feature 345 is configured as flat pad 346. The locating cups 338, 342 and the tertiary locating feature 345 (e.g., the flat pad 346) is mounted on the bottom of the station frame legs 352 of the station frame 350. The primary locating cup 338, the secondary locating cup 342, and the flat pad 346 are configured to engage respectively with the primary locating cone 332, the secondary locating home, and the rest button 336 of the cone system 322. To secure the station frame 350 to the floor 108, a threaded insert 330 is embedded in the floor 108 at the location of each cored hole 328. Each one of the station frame legs 352 may include a leg tab 354 protruding laterally from the lower end of each station frame leg 352. Each leg tab 354 may include a hole for receiving a mechanical fastener (e.g., a bolt) for threadably engaging the threaded insert 330 for securing the station frame 350 to the floor 108 when the cup system 324 of the station frame is mounted to the cone system 322 of the floor 108.

FIG. 14 shows an example of a pallet 160 mounted to the station frame 350 of FIG. 13 via the three-point locating system 320, and which is configured similar to the above-described three-point locating system 320 for coupling the station frame 350 to the floor 108 of the manufacturing cell 102. In this regard, the station frame 350 may include a cone system 322 as shown in FIG. 13 and described above, and which protrudes upwardly from the station frame panel 356. The pallet 160 may include a cup system 324 as described above. The cup system 324 of the pallet 160 is mounted to an underside of the pallet 160, and may engage with the cone system 322 protruding upwardly from the station frame panel 356. Advantageously, the three-point locating system 320 is configured to precisely and repeatably position each pallet 160 relative to the robotic device 200 (FIG. 6) within a relatively tight tolerance (e.g., within 0.010 inch) of a nominal position of the pallet 160 at the pallet station 300.

Although the cone system 322 is described as including two cones and one rest button, in an alternative example (not shown) the cone system 322 may include exactly three spheres configured to engage respectively with the primary locating cup 338, the secondary locating cup 342, and the flat pad 346 of the cup system 324. In a still further alternative example, instead of a cone system 322 being mounted to the floor 108 the manufacturing cell 102 and a cup system 324 being mounted to the bottom of the station frame legs 352, a cone system 322 is mounted to the bottom of the station frame legs 352, and a cup system 324 is mounted to the floor 108 the manufacturing cell 102. Likewise, instead of a cone system 322 protruding upwardly from the station frame panel 356 and a cup system 324 mounted to an underside of the pallet 160, the cone system 322 may be mounted to an underside of pallet 160, and the cup system 324 may be mounted to the station frame panel 356.

Referring to FIGS. 15-16, shown in FIG. 15 is an example of a station frame 350 configured to be mounted to the floor 108 (FIG. 14) of the manufacturing cell 102 via the above-described three-point locating system 320. As mentioned above, at each pallet station 300 (FIGS. 1-2) including at the first and second processing station 306, 308 (FIGS. 1-2) of a robotic device 200 (FIGS. 1-2), a station frame 350 is engaged to the floor 108 of the manufacturing cell 102 via a three-point locating system 320 as shown in FIG. 13. In addition, any one of the pallets 160 may be configured to be mounted to the station frame 350 at any pallet station 300, including at the first and second processing stations 306, 308, via a three-point locating system 320 as shown in FIG. 14.

In FIGS. 15-16, the station frame 350 is constructed of a rigid material such as metallic material (e.g., steel), and may include a station frame panel 356 supported on the station frame legs 352. The station frame panel 356 may be conspicuously marked and/or painted in bright colors to promote human awareness. A set of four tooling features 358 may be permanently mounted on the top side of the station frame 350. In the example shown, the tooling features 358 are configured as balls or spheres. However, the tooling features 358 may be provided in any one of a variety of alternative shapes, sizes, and configurations. The tooling features 358 may protrude upwardly from the station frame panel 356, and are used to verify, via a laser scanning system (not shown) or mechanical probing system (not shown), that the station frame 350 is located and oriented within a predetermined tolerance (e.g., within 0.010 inch) of a nominal position of the stations frame 350, relative to a world coordinate system (not shown) of the manufacturing cell 102.

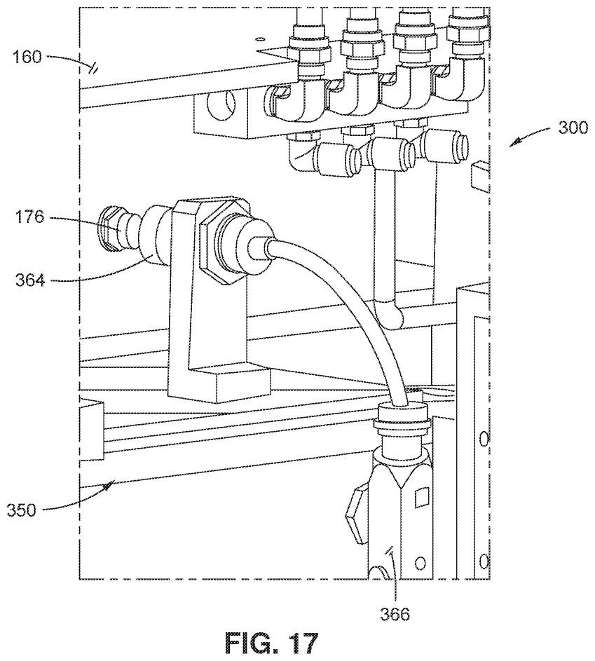

Referring to FIGS. 16-17, any one of the pallet stations 300 (including the processing stations 306, 308 in FIGS. 4A-4C) disclosed herein may include an RFID read/write head 364 coupled to an electrical connector 366, and powered by an electrical power cable (not shown) extending upwardly from the utilities pit 310 (FIG. 15) in the floor 108 of the manufacturing cell 102. The RFID read/write head 364 is configured to receive data from an RFID tag 176 (FIG. 17) mounted to the underside of each pallet 160, as a means for positively identifying each pallet 160, and for storing information about workpieces 186 that are mounted on the pallet 160 that is placed or located at the pallet station 300. Any one of the pallet stations 300 (including the processing stations 306, 308 in FIGS. 4A-4C) and/or any one of the station frames 350 disclosed herein may include a pallet presence switch 360 for detecting when a pallet 160 is placed or located at a pallet station 300, such as when a pallet 160 is loaded on the station frame 350.

In addition, in FIGS. 15-18, any one of the pallet stations 300 and/or the station frames 350 disclosed herein may include a station vacuum connector 369, such as a station vacuum cone 370, for vacuum coupling with a pallet vacuum connector 177, such as a pallet vacuum cup 178 (FIG. 18), that is included with each pallet 160 for maintaining vacuum coupling of the workpiece 186 (FIG. 6) to the workpiece mounting fixture 182 (FIG. 6), as described in greater detail below. In this regard, the pallet station 300 and/or the station frame 350 may also include a mechanical vacuum valve 362 for actuating the factory vacuum pressure source 116 when the pallet vacuum connector 177 (FIG. 18) engages with the station vacuum connector 369 after the cup system 324 (FIG. 18) of the pallet 160 engages with the cone system 322 (FIG. 13) of the station frame 350 as the pallet 160 placed at the station frame 350, as mentioned above and described in greater detail below.

Also shown in FIG. 16 is a compressed air conduit 368 (FIG. 15) extending upwardly out of the utilities pit 310 (FIG. 15) in the floor 108. The compressed air conduit 368 is fluidly coupled to a factory compressed air source 118, and may have a terminal end that is directed toward the station vacuum cone 370. During the process of locating a pallet 160 at a pallet station 300, such as by lowering a pallet 160 onto a station frame 350 via a transport device 400, the factory compressed air source 118 is commanded (e.g., by the controller 104 of the manufacturing cell 102) to direct a burst of compressed air from the compressed air conduit 368 onto the station vacuum cone 370 as a means to blow debris (e.g., carbon dust, metallic dust, etc.) off of the station vacuum cone 370 prior to the pallet vacuum cup 180 (FIG. 18) being lowered into engagement with the station vacuum cone 370, thereby ensuring a tight seal between the station vacuum cone 370 and the pallet vacuum cup 180.

Referring to FIGS. 18-19, shown is an underside of an example of a pallet 160. In any one of the manufacturing system 100 examples disclosed herein, the pallet 160 is constructed of a rigid material such as steel, and may include a pallet base panel 162 having a plurality of slotted holes (not shown) and/or tapered holes (not shown) to attach any one of a variety of different configurations of workpiece mounting fixtures 182 (FIG. 16). The pallet base panel 162 is supported by a pallet framework 164 (e.g., ribs, webs) to provide a high-stiffness and high-strength structure to which one or more workpiece mounting fixtures 182 is fastened. In the example of FIGS. 6-10, the pallet 160 may include a pair of fork tubes 166 configured to received a pair of vehicle forks 408 (FIG. 10). However, in an alternative example (e.g., FIGS. 4A-4C), the pallet 160 is provided without fork tubes 166, and the transport device 400 is provided without vehicle forks 408. In one such example, the transport device 400 is configured to move underneath the pallet 160 at a station frame 350, and vertically move the pallet 160 onto and off of the station frame 350. In another example, the transport device 400 (e.g., a drone, an overhead crane, etc.) is configured to attach to the pallet 160 from above, and may vertically move the pallet 160 onto and off of the pallet stations 300.

As described above, the pallet 160 includes the above-mentioned cup system 324 for engaging the cone system 322 (FIG. 15) of a station frame 350, or engaging the cone system 322 associated with the above-described conveyor system 420 (e.g., FIGS. 2A, 4A-4C, and 5A). In FIG. 18, the cup system 324 includes the primary locating cup 338, the secondary locating cup 342, and the tertiary locating feature 345, such as a flat pad 346. The primary locating cup 338 is centered on the pallet proximal end of the pallet 160. The pallet proximal end may be described as the end into which vehicle forks 408 are inserted into the fork tubes 166. The secondary locating cup 342 and the flat pad 346 may each be respectively located at the pallet distal end opposite the pallet proximal end. However, to match the arrangement of the primary locating cone 332, secondary locating cone 334, and tertiary locating element 335 of the locating system 316 in FIGS. 4A-4C, the primary locating cup 338 and the secondary locating cup 342 may be located on opposite ends of the pallet 160 and on one side of the pallet 160, and the tertiary locating feature 345 may be located at an approximate mid-point of the opposite side of the pallet 160.

As shown in FIG. 19, the primary locating cup 338 of any of the pallet 160 configurations disclosed herein is configured as a circular tapered hole 340. The secondary locating cup 342 of any of the pallet 160 configurations disclosed herein is configured as a slotted tapered hole 344. The slotted tapered hole 344 may have a slot axis (not shown) that is oriented perpendicular to an axis passing through the center of the slotted tapered hole 344 and the center of the tertiary locating feature 345 (e.g., the flat pad 346). The tertiary locating feature 345 or flat pad 346 may have a planar outer surface (e.g., FIG. 22). In any of the manufacturing system 100 examples disclosed herein, the engagement of the primary locating cone 332 (FIG. 15) with the circular tapered hole 340 of the primary locating cup 338 may constrain the pallet 160 from moving laterally at the primary locating cone 332. In addition, in any of the manufacturing system 100 examples disclosed herein, the engagement of the secondary locating cone 334 (FIG. 15) with the slotted tapered hole 344 of the secondary locating cup 342 may constrain the pallet 160 from pivoting about the primary locating cone 332, while accommodating slight differences in the distance between the primary locating cone 332 and the secondary locating cone 334 on different pallets 160. Furthermore, in any of the manufacturing system 100 examples disclosed herein, the engagement of the tertiary locating element 335 (e.g., the rest button 336) with the tertiary locating feature 345 (e.g., the planar outer surface of the flat pad 346) may constrain the orientation of the pallet 160, such as maintaining the pallet 160 in a horizontal orientation.

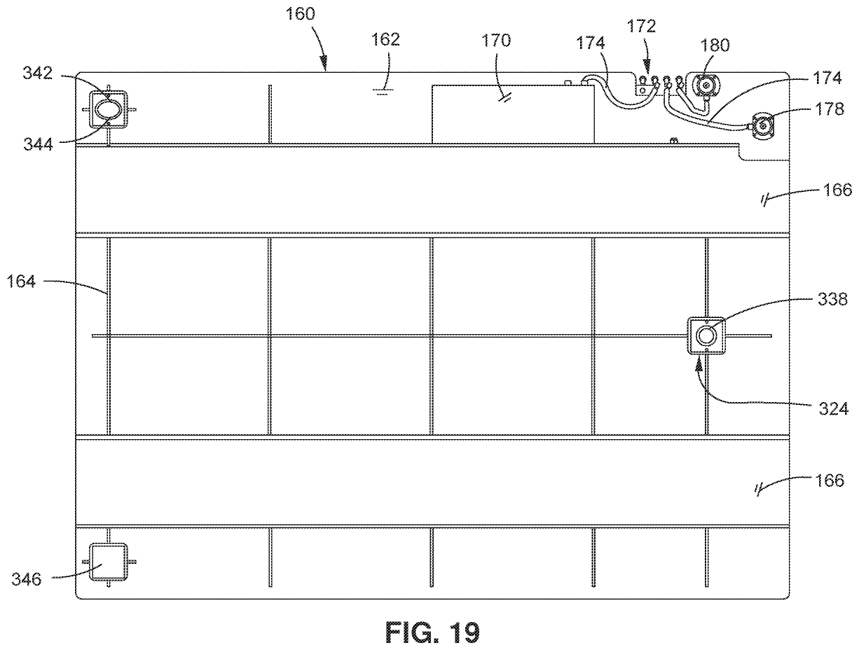

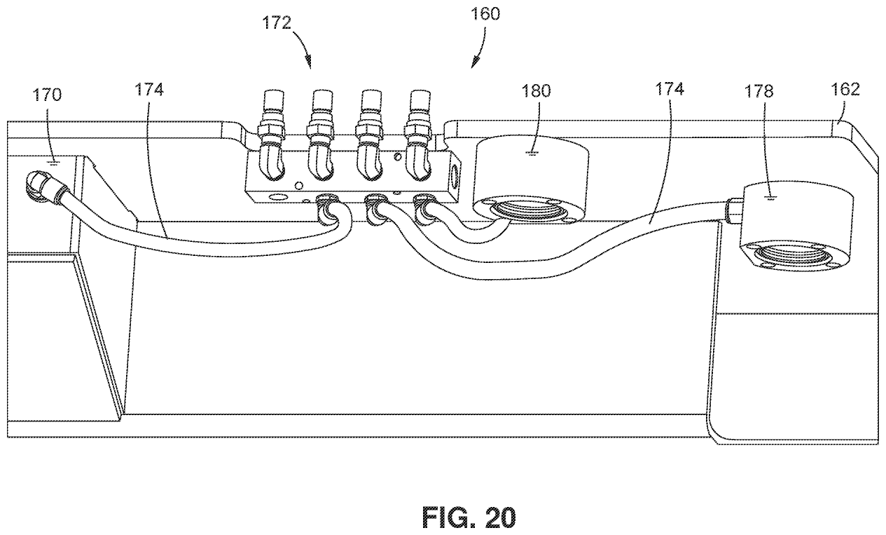

Referring still to FIGS. 18-20, as mentioned above, each pallet 160 may include one or more pallet vacuum connectors 177, such as pallet vacuum cups 178, 180, each of which is fluidly coupled to a vacuum manifold 172 via vacuum conduits 174. The transport devices 400 (FIG. 10) and the pallet stations 300 (FIG. 15), including the first and second processing stations 306, 308 (FIGS. 1-2), may each have a vacuum pressure source 114 (FIG. 15) fluidly couplable to the apertures 184 (FIG. 6) of the workpiece mounting fixture 182 (FIG. 6) for generating vacuum pressure at the apertures 184 to thereby vacuum couple the workpiece 186 to the mounting surface 188 (FIG. 6). The pallet 160 may also include a vacuum reserve tank 170 fluidly coupled to the vacuum manifold 172 via a vacuum conduit 174. As described in greater detail below, a pallet vacuum connector 177 (e.g., pallet vacuum cup 178) is configured to mate with the transport device vacuum connector 411 (e.g., transport device vacuum cone 412—FIGS. 10 and 32) when the pallet 160 is transported by a transport device 400. The pallet vacuum connector 177 (e.g., pallet vacuum cup 180) is configured to mate with the station vacuum connector 369 (e.g., station vacuum cone 370—FIG. 16) when the pallet 160 is mounted on a station frame 350 (e.g., FIG. 14), or when a pallet 160 is placed at a processing station 306, 308 (e.g., FIGS. 4B-4C). In the event of a loss of vacuum pressure from the factory vacuum pressure source 116 (FIG. 15) and/or from the transport device vacuum source 410 (FIG. 10), the vacuum reserve tank 170 may provide backup vacuum pressure to the apertures 184 to maintain vacuum coupling of the workpiece 186 to the workpiece mounting fixture 182.

Referring to FIGS. 21-22, shown in FIG. 21 is a sectional view of an example of the primary or secondary locating cup 338, 342 of the station frame 350 respectively mounted on the primary or secondary locating cone 332, 334 on the floor 108 of the manufacturing cell 102. The primary and secondary locating cups 338, 342 of the station frame 350 may each be coupled to a bottom of a station frame leg 352. As mentioned above, the primary and secondary locating cones 332, 334 is threadably engaged respectively to embedded plates 326 that are adhesively bonded within a cored hole 328 in the floor 108. Also shown in FIG. 21 is the primary or secondary locating cup 338, 342 of the pallet 160 respectively mounted on the primary or secondary locating cone 332, 334 of the station frame 350. The primary and secondary locating cups 338, 342 of the pallet 160 are coupled to the pallet framework 164 on the underside of the pallet 160. The primary and secondary locating cones 332, 334 of the station frame 350 may protrude upwardly from the station frame panel 356.

FIG. 22 is a sectional showing an example of the flat pad 346 of the station frame 350 resting on the rest button 336 on the floor 108 of the manufacturing cell 102 via an embedded plate 326. The flat pad 346 of the station frame 350 is coupled to the bottom of a station frame leg 352. The rest button 336 is threadably engaged to an embedded plate 326 bonded within a cored hole 328 in the floor 108. Also shown is the flat pad 346 of the pallet 160 mounted on the rest button 336 of the pallet station 300. The flat pad 346 of the pallet 160 is coupled to the pallet framework 164 on the underside of the pallet 160. The rest button 336 of the station frame 350 may protrude upwardly from the station frame panel 356.

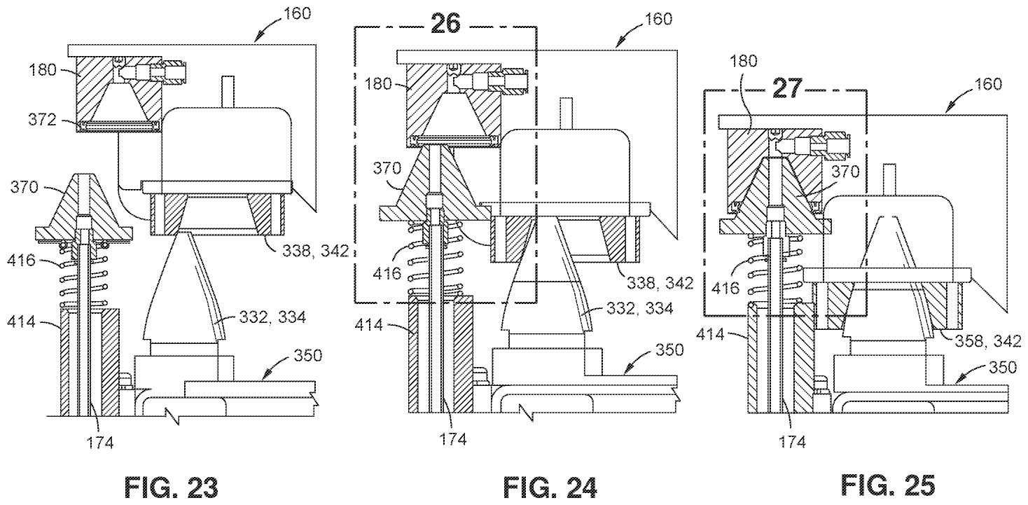

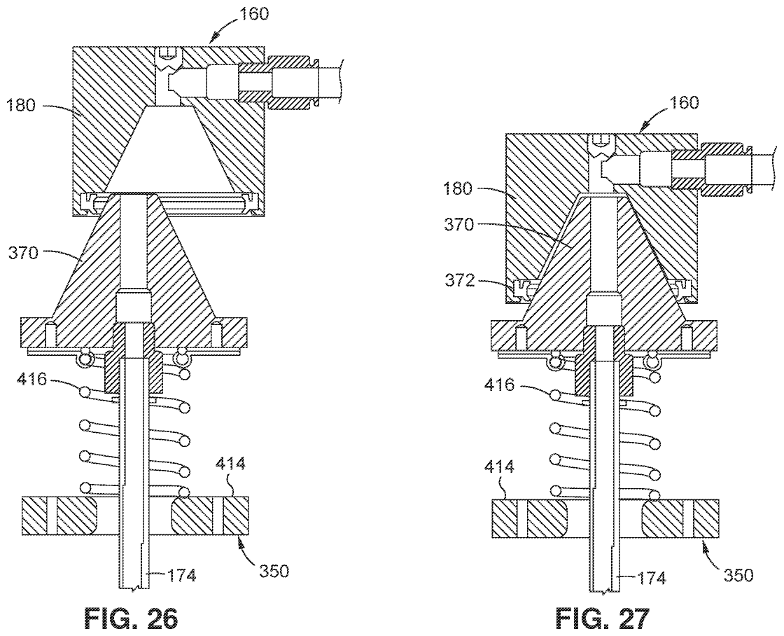

Referring to FIGS. 23-27, shown in FIGS. 23-25 are sectional views of a portion of a pallet 160 and a station frame 350 as the pallet 160 is lowered onto the station frame 350, and illustrating the process of the primary or secondary locating cup 338, 342 of the pallet 160 respectively engaging the primary or secondary locating cone 332, 334 of the station frame 350, and also illustrating the engagement of the pallet vacuum cup 180 of the pallet 160 with a station vacuum cone 370 of the station frame 350. FIGS. 26-27 are magnified views showing the engagement of the pallet vacuum cup 180 with the station vacuum cone 370. As described above, each of the pallets 160 in FIGS. 23-27 has a pallet vacuum cup 180 which is mounted to the underside of the pallet 160 (FIGS. 18-19). The pallet stations 300 in FIGS. 23-27, including the first and second processing stations 306, 308 (FIGS. 1-2), may each include a station vacuum cone 370. The station vacuum cone 370 is fluidly coupled to a vacuum conduit 174 extending out of the utilities pit 310 (FIG. 15) at each pallet station 300. The vacuum conduit 174 may be fluidly coupled to a factory vacuum pressure source 116 (e.g., a factory vacuum pump).

As shown in FIGS. 23-27, the station vacuum cone 370 is configured to sealingly engage with the pallet vacuum cup 180 when the transport device 400 places the pallet 160 at the first or second processing station 306, 308, thereby providing vacuum pressure at the apertures 184 (FIG. 6) of the mounting surface 188 (FIG. 6) of the workpiece mounting fixture 182 for holding the workpiece 186 and fixed position when the workpiece 186 is operated on by the robotic device 200. The station vacuum cone 370 is supported on a cone spring 416 mounted on a mounting bracket 414, which is mounted to the station frame 350. The pallet vacuum cup 180 may include a circumferential seal 372 (e.g., a wiper seal) located at the base of the pallet vacuum cup 180. The circumferential seal 372 may facilitate sealing engagement of the pallet vacuum cup 180 to the station vacuum cone 370 when the pallet 160 is lowered onto the station frame 350 at the first or second processing station 306, 308. The cone spring 416 is configured to urge the station vacuum cone 370 upwardly toward the pallet vacuum cup 180, to thereby maintain sealing engagement of the outer surface of the station vacuum cone 370 with the circumferential seal 372. In addition, the cone spring 416 may allow the station vacuum cone 370 to laterally move into alignment with the pallet vacuum cup 180 to facilitate sealing engagement therebetween.

As shown in FIG. 23, when the transport device 400 transports a pallet 160 to a new pallet station 300, the pallet 160 may initially be slightly laterally offset from the station frame 350. More specifically, the cup system 324 (FIG. 18) of the pallet 160 may initially be laterally offset from the cone system 322 (FIG. 13) of the station frame 350. As a result, the pallet vacuum cup 180 may also be laterally offset from the station vacuum cone 370. The height of the primary and secondary locating cones 332, 334 are greater than the height of the station vacuum cone 370, thereby causing the primary and secondary locating cones 332, 334 to respectively engage with the primary and secondary locating cups 338, 342 prior to engagement of the station vacuum cone 370 with the pallet vacuum cup 180.

FIG. 24 shows the pallet 160 further lowered onto the station frame 350, and illustrating the further engagement of the primary locating cup 338 (or secondary locating cup 342) of the pallet 160 with the primary locating cone 332 (or secondary locating cone 334) of the station frame 350. FIG. 26 is a magnified view showing the pallet vacuum cup 180 initially laterally offset from the station vacuum cone 370 during the process of lowering the pallet 160 onto the station frame 350. As a result of the conical shape of the primary and secondary locating cones 332, 334, the lowering of the pallet 160 onto the station frame 350 causes the side surfaces of the primary or secondary locating cones 332, 334 to engage the side surfaces respectively of the primary and secondary locating cups 338, 342, thereby laterally shifting the pallet 160 causing the pallet vacuum cup 180 to move toward axial alignment with the station vacuum cone 370, similar to the above-described self-alignment process associated with the conveyor system 420 arrangement illustrated in FIGS. 4B-4C.

FIG. 25 shows the pallet 160 lowered onto the station frame 350, and illustrating the full engagement of the primary locating cup 338 (or secondary locating cup 342) of the pallet 160 with the primary locating cone 332 (or secondary locating cone 334) of the station frame 350, and allowing the pallet vacuum cup 180 to engage with the station vacuum cone 370. FIG. 27 is a magnified view showing the pallet 160 completely lowered onto the station frame 350, and the pallet vacuum cup 180 sealed to the station vacuum cone 370 via the circumferential seal 372. As mentioned above, when a pallet 160 is lowered onto a station frame 350, the mechanical vacuum valve 362 (FIG. 16) is activated to thereby fluidly couple the pallet vacuum cup 180 to the factory vacuum pressure source 116 (FIG. 15), and resulting in vacuum pressure at the apertures 184 (FIG. 6) of the workpiece mounting fixture 182.

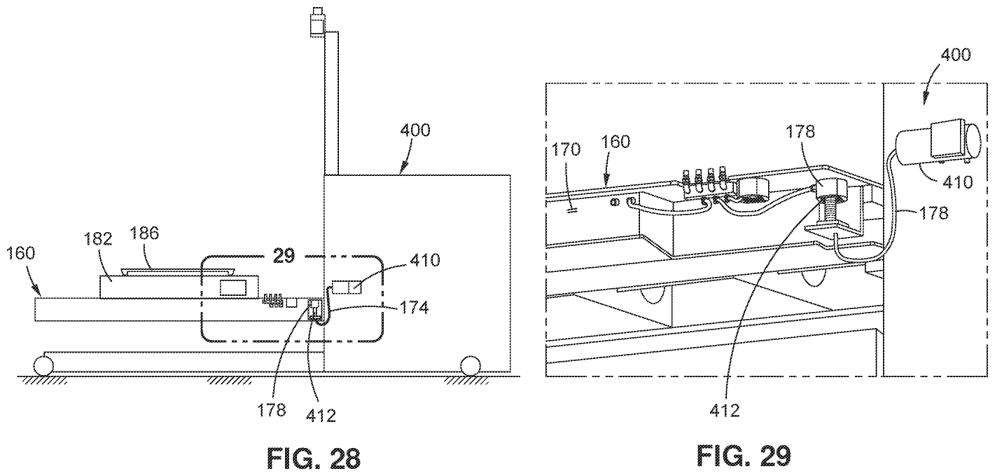

Referring to FIGS. 28-32, shown in FIG. 28 is an example of a transport device 400 transporting a pallet 160 supporting a workpiece 186 mounted on a workpiece mounting fixture 182. As mentioned above, the transport device 400 may include one or more transport device vacuum sources 410 (e.g., vacuum pumps). The transport device 400 may also include a transport device vacuum cone 412 (FIG. 32) which is fluidly coupled to the one or more transport device vacuum sources 410 via a vacuum conduit 174. In the example of FIGS. 28-29, the transport device vacuum cone 412 is mounted to the transport device 400. For example, the transport device vacuum cone 412 may be mounted to one of the vehicle forks 408 via a mounting bracket 414. The transport device vacuum cone 412 is supported by a cone spring 416 similar to the mounting arrangement of the station vacuum cone 370. As described above, each of the pallets 160 may have a pallet vacuum connector 177. In FIG. 16, the pallet vacuum connector 177 is a pallet vacuum cup 178 opening downwardly and located on an underside of the pallet base panel 162.

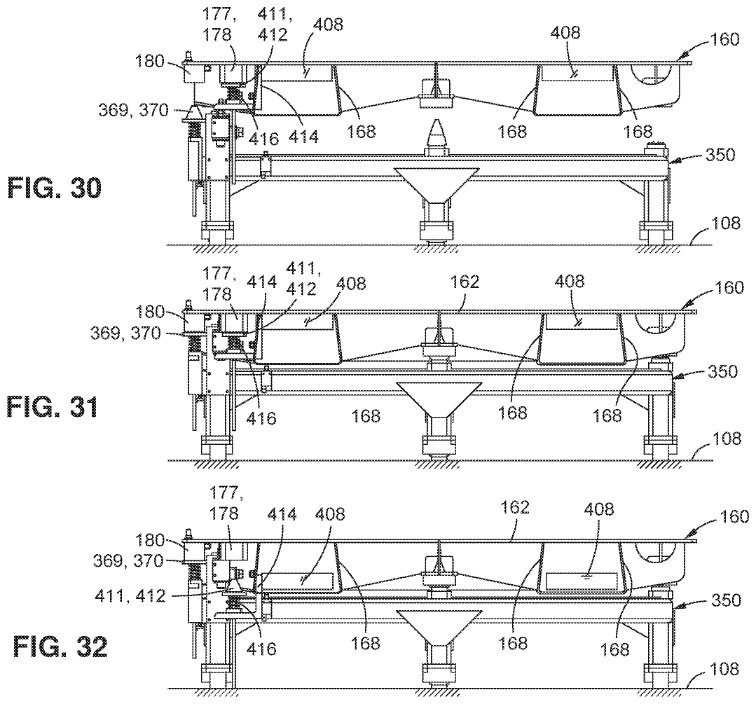

FIG. 30 shows a pallet 160 during the initial stage of being lowered by a transport device 400 onto a station frame 350. The pallet vacuum cup 178 of the pallet 160 is initially engaged to the transport device vacuum cone 412 of the transport device 400, while the pallet vacuum cup 180 of the pallet 160 is vertically separated from the station vacuum cone 370 of the station frame 350, similar to the above-described arrangement shown in FIG. 23. FIG. 31 shows the pallet 160 further lowered onto the station frame 350, and illustrating the pallet vacuum cup 178 of the pallet 160 still engaged to the transport device vacuum cone 412 of the transport device 400, and also showing the pallet vacuum cup 180 of the pallet 160 engaged to the station vacuum cone 370 of the station frame 350 similar to the arrangement shown in FIG. 27. FIG. 32 shows the pallet 160 completely lowered onto the station frame 350. The vehicle forks 408 are further lowered, causing the pallet vacuum cup 178 of the pallet 160 to disengage from the transport device vacuum cone 412 of the transport device 400, while the pallet vacuum cup 180 of the pallet 160 remains engaged to the station vacuum cone 370. Advantageously, the arrangement of the vacuum cups 178, 180 and vacuum cones 370, 412 allows for uninterrupted vacuum pressure at the mounting surface 188 of the workpiece mounting fixture 182 during the transfer of the pallet 160 onto and off of the station frame 350.

When it is time for the pallet 160 to be removed the station frame 350, a transport device 400 (FIG. 10) may approach the pallet 160 to cause the vehicle forks 408 to be inserted into the fork tubes 166 of the pallet 160. As shown in FIGS. 30-32, each of the fork tubes 166 has opposing side walls 168 that are narrower at the top of the fork tubes 166 than at the bottom of the fork tubes 166, and causing the pallet 160 to self-center on the vehicle forks 408 when the vehicle forks 408 are inserted into the fork tubes 166 and vertically raised into engagement with the pallet 160 to lift the pallet 160 off of the pallet station 300. As the vehicle forks 408 are raised, the transport device vacuum cone 412 is configured to sealingly engage with the pallet vacuum cup 178, after which the pallet vacuum cup 180 disengages from the station vacuum cone 370. The engagement of the transport device vacuum cone 412 to the pallet vacuum cup 178 fluidly couples the transport device vacuum cone 412 to the transport device vacuum pump 410. The transport device vacuum pump 410 (FIG. 10) provides vacuum pressure at the apertures 184 of the workpiece mounting fixture 182 for maintaining vacuum coupling of the workpiece 186 to the mounting surface 188 (FIG. 6) of the workpiece mounting fixture 182 when the pallet 160 is transported by the transport device 400.

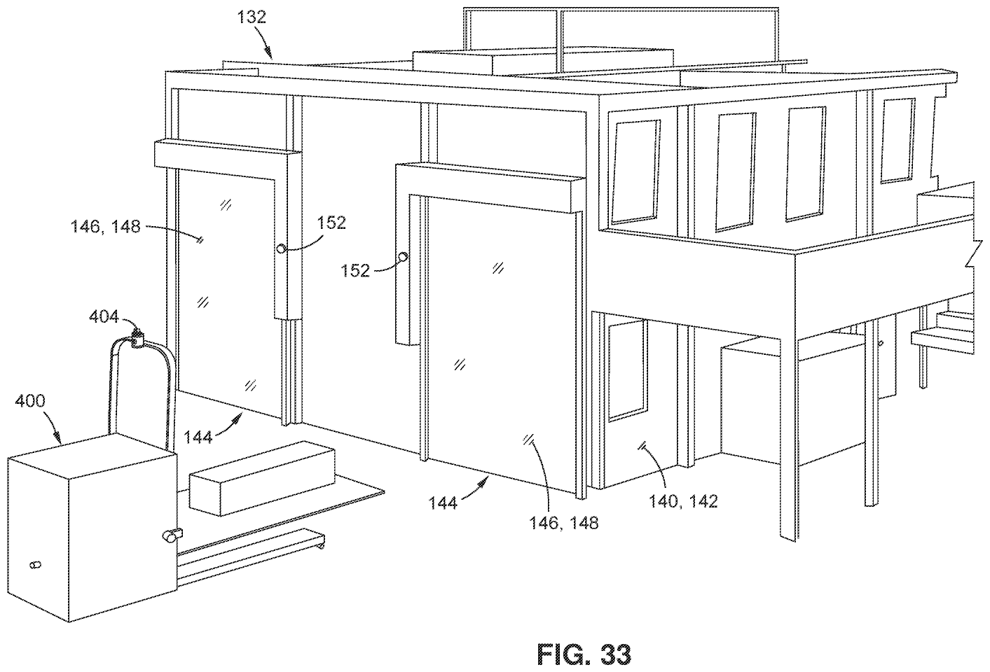

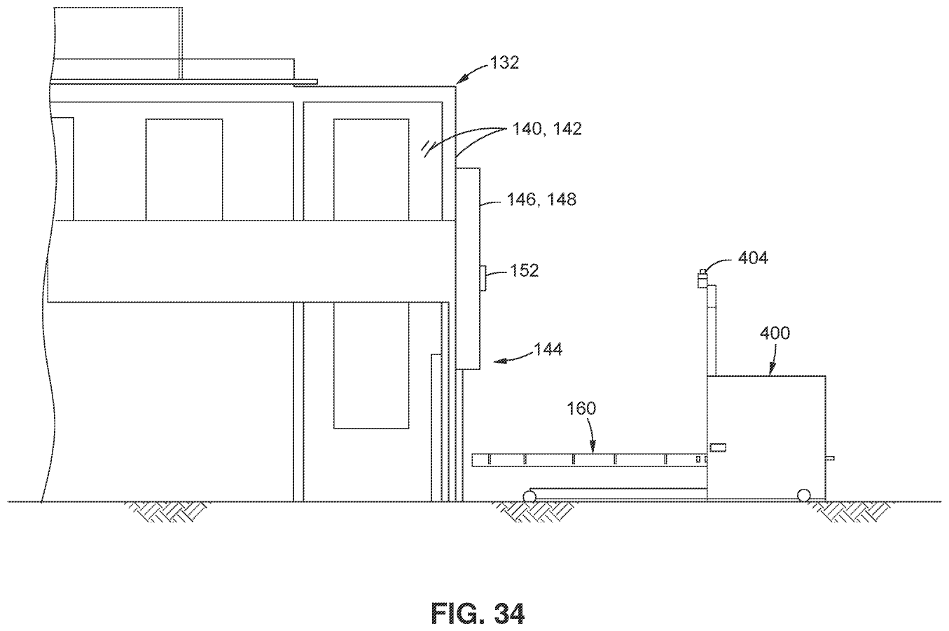

Referring to FIGS. 33-34, shown is an example of a transport device 400 approaching an entrance 144 to the machining subcell 132. As mentioned above, a manufacturing cell 102 may include any number of subcells 130, each having a subcell boundary 140 at least partially enclosing the subcell 130. The subcell boundary 140 may separate the subcell 130 from the remainder of the manufacturing cell 102, and may prevent human access into the subcell 130 for safety reasons, and may also prevent the escape of debris such as machining dust (e.g., carbon dust) that may be generated during manufacturing operations (e.g., trimming, sanding, etc.) By the one or more robotic devices 200 in the machining subcell 132.

In any one of the manufacturing system 100 examples disclosed herein, the subcell boundary 140 has at least one entrance 144 for passage of a transport device 400 into and out of the subcell 130. At least one of the entrances 144 may have a pass-through sensor 152 In addition, at least one of the entrances 144 may have an entrance barrier 146 (e.g., a subcell door 148) that is selectively configurable to either prevent or allow passage of the transport device 400 through the entrance 144 for either entering or exiting the subcell 130. The pass-through sensor 152 may be a laser scanner or a curtain on an exterior side and/or an interior side of the subcell boundary 140 proximate the entrance 144. The subcell boundary 140 may comprise physical subcell walls 142, physical fencing, a physical curtain, or other physical boundary structure. As mentioned above, the entrance barrier 146 may be a physical subcell door 148 (e.g., a roll-up door, a side-hinged door, a gate, etc.). Alternatively or additionally, the entrance barrier 146 may be a non-physical barrier. For example, each entrance barrier 146 may include an optical safety curtain (not shown) generated by one or more door laser scanners (not shown) configured to scan in a two-dimensional plane across the entrance 144. The transport devices 400 may each have physical features (not shown) that penetrate the optical safety curtain at specific locations and in specific order as the transport device 400 passes through the entrance, as a means to confirm that a transport device 400 is entering the subcell, and not a person.

As mentioned above, for transport devices 400 configured as a vehicle, the transport device 400 may have at least one vehicle signaling device 404 (e.g., a laser beacon, a wireless transmitting device, etc.) configured to emit or transmit a transport device signal (e.g., a laser beam, a wireless signal, etc.). The pass-through sensor 152 at the entrance 144 to the subcell 130 is configured to sense or receive the transport device signal when the transport device 400 approaches or is near the entrance 144 to the subcell 130, and/or is within a predetermined distance (e.g., 10 feet) of the entrance 144. For examples where the pass-through sensor 152 is a wireless receiver configured to receive a wireless signal transmitted by a transport device-mounted wireless transmitting device, the wireless signal may be transmitted over a dedicated wifi network. The wireless signal may include a request for opening the entrance 144.

The controller 104 (FIG. 2), in response to the pass-through sensor 152 sensing or receiving a transport device signal, may determine whether or not to allow the transport device 400 to pass through the entrance 144. If allowed to pass, the controller 104 may command the entrance barrier 146 to allow passage of the transport device 400 through the entrance 144. For example, in the case of the machining subcell 132, when the pass-through sensor 152 senses the transport device signal of an approaching transport device 400, the controller 104 determine whether to allow the transport device 400 to pass through the entrance 144, and may open the subcell door 148 to allow the transport device 400 to either enter or exit the machining subcell 132, depending on whether the transport device 400 is inside or outside of the machining subcell 132. In the case of the inspection subcell 134, the controller 104 may allow a transport device 400 to pass through the entrance 144 when the pass-through sensor 152 of the inspection subcell 134 receives the transport device signal of an approaching transport device 400. After the transport device 400 has passed through the entrance 144 and is moving away from the entrance 144, the controller 104 may reactivate the entrance barrier 146 (e.g., close the subcell door 148) to prevent passage through the entrance 144. The entrance 144 may remain closed at all other times, unless manually commanded to open by an operator.

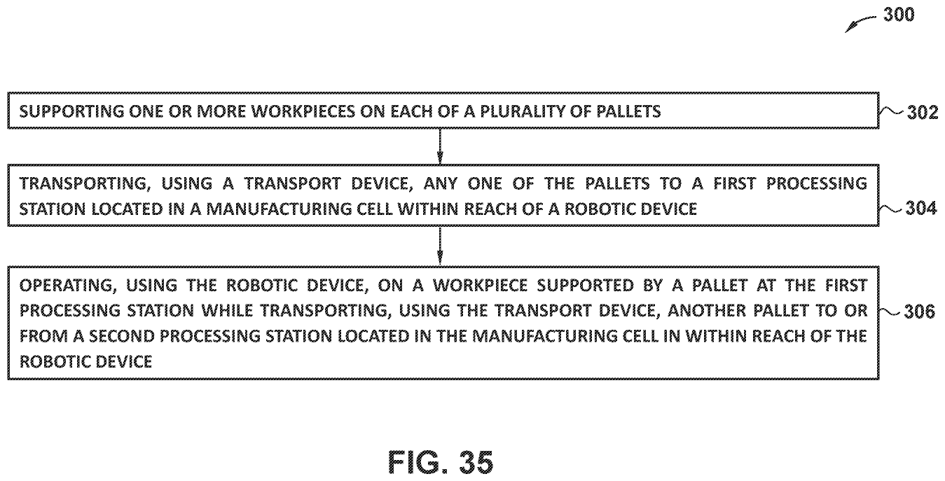

Referring to FIG. 35, shown is a flowchart of steps of a method 500 of processing workpieces 186 using any one of the manufacturing cell 102 examples described above. Step 502 of the method 500 includes supporting one or more workpieces 186 on each of a plurality of pallets 160. As mentioned above, each pallet 160 may include one or more workpiece mounting fixtures 182 which are each pallet 160 is configured to support one or more workpieces 186. Each of the workpieces 186 is loaded (e.g., by a technician) onto the workpiece mounting fixture 182 of a pallet 160 prior to the pallet 160 being loaded (e.g., via a manually-operated forklift or crane) onto a feed station 302.

Step 504 of the method 500 includes transporting, using a transport device 400, any one of the pallets 160 to a first processing station 306, which is located within reach of a robotic device 200. As described above, the manufacturing cell 102 includes one or more transport devices 400 configured to transport pallets 160 between different pallet stations 300. As described above, the one or more transport devices 400 may comprise overhead equipment such as cranes or gantries (not shown), or drones (not shown). In another example, the transport devices 400 may comprise the above-described floor-mounted conveyor system 420 (FIGS. 2A, 4A-4C, and 5A), and step 504 may comprise transporting the pallets 160 using a plurality of conveyor sections 422 extending along transport device routes between the plurality of pallet stations 300.

In an example where the transport devices 400 are vehicles, the process of transporting a pallet 160 may include inserting a pair of vertically movable vehicle forks 408 of a transport device 400 into a pair of fork tubes 166 of the pallet 160. The pallet 160 is supported on a station frame 350 at the feed station 302. The method may include transporting any one of the plurality of pallets 160 to and/or from a feed station 302, which is configured to support any one of the pallets 160 prior to pickup or engagement by a transport device 400 for transporting the pallet 160 to one or more processing stations 306, 308. The method may also include transporting any one of the pallets 160 to and/or from a buffer queuing station 304 configured to temporarily support any one of the pallets 160 in between processing operations at one of the processing stations 306, 308.

As mentioned above, the opposing side walls 168 of each fork tube 166 may be narrower at the top of the fork tube 166 than at the bottom. The method may include raising the vehicle forks 408 while inside the fork tubes 166 to thereby lift the pallet 160, and causing each vehicle fork 408 to engage with one of the side walls 168 of the fork tubes 166. As a result, the method includes self-centering the pallet 160 on the pair of vehicle forks 408 due to engagement of the vehicle forks 408 with the side walls 168 of the fork tubes 166 when raising the vehicle forks 408 inside the fork tubes 166 to lift the pallet 160. Upon arriving at another pallet station 300 such as a first processing station 306, the method may include lowering the vehicle forks 408 to place the pallet 160 on the station frame 350 at the first processing station 306.

Step 506 of the method 500 includes operating, using the robotic device 200, on a workpiece 186 supported by the pallet 160 at the first processing station 306 while transporting, using a transport device 400, another pallet 160 to or from a second processing station 308, which is located within reach of the robotic device 200. The method may include controlling, using a controller 104 of the manufacturing cell 102, the movement of the transport devices 400 and the robotic device 200 in a manner allowing the robotic device 200 to continuously operate on workpieces 186 during the movement of the pallets 160 by a transport device 400 to and from a second processing station 308. In this manner, the manufacturing system 100 significantly reduces or eliminates human intervention in workpiece transporting, handling, and processing (e.g., machining, inspection, cleaning, etc.), which advantageously increases the consistency of workpiece processing, and also reduces operational time and labor cost.

The method 500 may include coupling, using at least one locating system 316 (e.g., a three-point locating system 320), the pallet 160 to the first and/or second processing station 306, 308 in a precise and repeatable location and orientation relative to the robotic device 200. In this regard, the method may include coupling any pallet 160 to any one of the pallet stations 300 using the above-described three-point locating system 320. As indicated above, each one of the pallet stations 300, including the feed stations 302 and the buffer queuing locations 304, may utilize a three-point locating system 320 for accurately locating pallets 160 at the pallet stations 300. The step of coupling any one of the pallets 160 to either the first or second processing station 306, 308 may include coupling a cup system 324 of a pallet 160 to a cone system 322 included with the first and/or the second processing station 306, 308. As described above, the cone system 322 in one example has a primary locating cone 332, a secondary locating cone 334, and a tertiary locating element 335 (e.g., a rest button 336) arranged in a triangular pattern. The cup system 324 has a primary locating cup 338, a secondary locating cup 342, and a tertiary locating feature 345 (e.g., a flat pad 346) also arranged in a triangular pattern, and configured to engage respectively with the primary locating cone 332, the secondary locating cone 334, and the tertiary locating element 335 of the cone system 322.

As mentioned above, in the example of FIGS. 2, 4, 5, and 6, each one of the pallet stations 300 has a station frame 350 that is mounted to the floor 108 of the manufacturing cell 102. In such an arrangement, the method may include mounting, via a three-point locating system 320, a station frame 350 to a floor 108 of the manufacturing cell 102 at each of the first and second processing stations 306, 308, and mounting, via another three-point locating system 320, any one of the pallets 160 to the station frame 350 at each of the first and second processing stations 306, 308. To facilitate the mounting of the station frame 350 to the floor 108 of the manufacturing cell 102, the method may include mounting each of a primary locating cone 332, a secondary locating cone 334, and a rest button 336 to an embedded plate 326 contained with a cored hole 328 formed in the floor 108 of the manufacturing cell 102. The method may further include engaging the primary locating cone 332, the secondary locating cone 334, and the rest button 336 respectively to the primary locating cup 338, the secondary locating cup 342, and the flat pad 346 respectively included with three station frame legs 352 extending downwardly from the station frame 350.

In the example of FIGS. 4A-4C which has a conveyor system 420 as the transport device 400, the process of coupling a pallet 160 to either the first processing station 306 or the second processing station 308 includes transporting the pallet 160 into one of the processing stations 306, 308 proximate a robotic device 200. The process further includes moving, via locating point actuators 319, the locating points 321 (e.g., the primary locating cone 332, the second locating cone 334, and the tertiary locating element 335 upwardly into engagement respectively with the primary locating cup 338, the secondary locating cup 342, and the tertiary locating feature 345 (e.g., a planar underside) of the pallet 160, and lifting the pallet 160 off of the conveyor belt 426. The locating points 321 may non-movably support the pallet 160 above the conveyor belt 426 in a precise location and orientation relative to the robotic device 200 while the robotic device 200 operates on the workpiece 186.

When loading a pallet 160 onto a station frame 350 or placing a pallet 160 at a pallet station 300 (e.g., at a first or second processing station 306, 308), the method may include, reading, via an RFID read/write head 364 on the station frame 350, an RFID tag 176 included with each pallet 160 to allow the controller 104 to positively identify the pallet 160 that is loaded onto the station frame 350 or placed at the pallet station 300. In addition, the method may include detecting, via a pallet presence switch 360, the presence of the pallet 160 when loading a pallet 160 onto a station frame 350 or placing a pallet 160 at a pallet station 300. Occasionally, the method may include verifying, using a set of tooling features 358 mounted at the pallet station 300 and/or on the station frame 350, the location of the pallet station 300 or station frame 350 relative to a world coordinate system of the manufacturing cell 102.

Step 502 of supporting one or more workpieces 186 on each of the pallets 160 may comprise supporting one or more workpiece mounting fixtures 182 on at least one of the pallets 160. As described above, at least one of the workpiece mounting fixtures 182 may have a mounting surface 188 containing a plurality of apertures 184. The method may include mounting a workpiece 186 on the mounting surface 188 of the workpiece mounting fixture 182. In addition, the method may include vacuum coupling the workpiece 186 to the mounting surface 188 when transporting the pallet 160 (e.g., via a transport device 400) using the vacuum pressure source 114 of the transport device 400 (e.g., a transport device vacuum source 410, such as a vacuum pump), and vacuum coupling the workpiece 186 to the mounting surface 188 when supporting the pallet 160 at the first and/or second processing station 306, 308 using the vacuum pressure source 114 respectively at the first and/or second processing stations 306, 308 (e.g., the factory vacuum pressure source 116).

Vacuum coupling of the workpiece 186 to the mounting surface 188 when transporting the pallet 160 via the transport device 400 may include raising the transport device 400 into engagement with the pallet 160 for lifting the pallet 160 off of the pallet station 300. For example, as mentioned above, the transport device 400 may have a pair of vehicle forks 408 that are inserted into a pair of fork tubes 166 included with the pallet 160. The transport device 400 also includes a transport device vacuum cone 412 mounted to the transport device 400. The transport device vacuum cone 412 is mounted on a cone spring 416. The cone spring 416 may urge the transport device vacuum cone 412 upwardly into engagement with the pallet vacuum cup 178 of the pallet 160.

The transport device vacuum cone 412 is fluidly coupled to the transport device vacuum source 410 (e.g., vacuum pump). The method may include sealingly engaging the transport device vacuum cone 412 with the pallet vacuum cup 178 of the pallet 160 when raising the vehicle forks 408 into engagement with the pallet 160. For example, the method may include sealing, using a circumferential seal 372, the pallet vacuum cup 178 to the transport device vacuum cone 412. The method may include activating the transport device vacuum source 410 to generate vacuum pressure at the apertures 184 of the mounting surface 188 for vacuum coupling the workpiece 186 to the workpiece mounting fixture 182 when the pallet 160 is supported and/or transported by the transport device 400.

Vacuum coupling of the workpiece 186 to the mounting surface 188 when supporting the pallet 160 on the first or second processing station 306, 308 may comprise lowering, using the transport device 400 (e.g., the vehicle forks 408), the pallet 160 onto the first or second processing station 306, 308. As described above, the first and second processing station 306, 308 may each have a station frame 350 having a station vacuum cone 370 fluidly coupled (e.g., via the utilities pit 310) to the factory vacuum pressure source 116. Prior to the pallet vacuum cup 180 being lowered onto the station vacuum cone 370, the method may include directing, using a compressed air conduit 368 at the station frame 350, a burst of compressed air toward the station vacuum cone 370 to remove any debris (e.g., machining dust) that may be on the station vacuum cone 370.

The method may include sealingly engaging, via the circumferential seal 372, the station vacuum cone 370 with the pallet vacuum cup 180 of the pallet 160 when lowering the pallet 160 onto the station frame 350. The method may also include activating the factory vacuum pressure source 116 by triggering the mechanical vacuum valve 362 (FIG. 16) to thereby generate vacuum pressure at the apertures 184 of the mounting surface 188 of the workpiece mounting fixture 182 for vacuum coupling the workpiece 186 to the workpiece mounting fixture 182 at one of the first or second processing station 306, 308. To accommodate the potential loss of vacuum pressure provided by the factory vacuum pressure source 116 or by the transport device vacuum source 410, the method may additionally include maintaining vacuum coupling of the workpiece 186 to the mounting surface 188 using a vacuum reserve tank 170 that is included with the pallet 160.

For examples of the manufacturing cell 102 having a subcell 130 (e.g., machining subcell 132, inspection subcell 134, etc.) that is at least partially enclosed by a subcell boundary 140 (e.g., subcell walls 142, safety fence 154, etc.) as described above, the method may include moving the transport device 400 toward an entrance 144 of the subcell. As described above, the entrance 144 of the subcell 130 may include at least one pass-through sensor 152. In addition, the entrance 144 may include an entrance barrier 146 that is selectively configurable to either prevent or allow passage of the transport device 400 through the entrance 144. As described above, the entrance barrier 146 may be a physical subcell door 148, as may be included with the machining subcell 132. Alternatively, the entrance barrier 146 may be an optical safety curtain (not shown) generated by one or more door laser scanners (not shown), as may be included with the inspection subcell 134.

When a transport device 400 approaches the entrance 144, the method may include emitting, using a vehicle signaling device 404 (e.g., a transport device laser beacon), a transport device signal such as a laser beam. Alternatively, the vehicle signaling device 404 may be a wireless transmitting device (not shown) configured to transmit a wireless signal (i.e., the transport device signal) over a dedicated wifi network. As mentioned above, the wireless signal may include a request for opening the entrance 144. The method may additionally include sensing, using the pass-through sensor 152, the transport device signal when the transport device 400 is within a predetermined distance of the entrance 144 and is facing toward the entrance 144. For example, the pass-through sensor 152 may receive a wireless signal, which may include a request (i.e., to the controller 104) to allow the transport device 400 to pass through the entrance 144. The method may also include commanding, using the manufacturing cell 102 controller 104, in response to the pass-through sensor 152 sensing or receiving the transport device signal, the entrance barrier 146 to allow passage of the transport device 400 through the entrance 144, such as by opening the subcell door 148 of the machining subcell 132, and/or deactivating the door laser scanners of the inspection subcell 134, and/or allowing the transport device 400 to pass through the two-dimensional optical curtain generating by the door laser scanners.

Additional modifications and improvements of the present disclosure may be apparent to those of ordinary skill in the art. Thus, the particular combination of parts described and illustrated herein is intended to represent only certain examples of the present disclosure and is not intended to serve as limitations of alternative examples or devices within the spirit and scope of the disclosure.

What is claimed is:

1. A manufacturing system for processing workpieces, comprising:
a manufacturing cell;
a plurality of pallets each configured to support one or more workpieces;
at least one robotic device mounted in the manufacturing cell and configured to operate on the one or more workpieces;
at least two processing stations, including a first processing station and a second processing station, each located in the manufacturing cell and each configured to support any one of the plurality of pallets in fixed position relative to the robotic device;
a transport device configured to transport any one of the plurality of pallets to and from each of the first processing station and the second processing station; and
a controller configured to coordinate the operation of the manufacturing cell in a manner allowing the robotic device to continuously operate on a workpiece supported by one of the plurality of pallets at the first processing station while another one of the plurality of pallets is transferred to or from the second processing station.

2. The manufacturing system of claim 1, wherein:
the manufacturing cell includes a plurality of pallet stations, each configured to support one of the plurality of pallets.

3. The manufacturing system of claim 2, wherein the pallet stations are configured as at least one of the following:
a processing station;
a feed station configured to support any one of the plurality of pallets prior to transporting of the pallet, via the transport device, from the feed station to one of the processing stations; and
a buffer queuing station configured to temporarily support any one of the pallets in between processing operations at one of the processing stations.

4. The manufacturing system of claim 1, wherein:
the transport device comprises a conveyor system having a plurality of conveyor sections extending along transport device routes between the plurality of pallet stations.

5. The manufacturing system of claim 1, further comprising:
a locating system configured to couple any one of the pallets to either one of the first and second processing stations in a precise and repeatable location and orientation relative to the robotic device.

6. The manufacturing system of claim 5, wherein
the locating system is a three-point locating system having three locating points arranged in a triangular pattern.

7. The manufacturing system of claim 6, wherein the locating system comprises:
a cone system included with each of the first and second processing stations, and having locating cones; and
a cup system included with each of the pallets, and having locating cups configured to engage respectively with the locating cones.

8. The manufacturing system of claim 7, wherein:
the locating cones each have a generally conical outer surface; and
two of the locating cups comprise, respectively, a circular tapered hole, and a slotted tapered hole.

9. The manufacturing system of claim 1, wherein at least one of the processing stations includes at least one of the following:
an RFID read/write head configured to read an RFID tag included with each pallet to allow the controller to positively identify the pallet located at the first processing station and/or at the second processing station; and
a set of tooling features for verifying the location of the pallet relative to a world coordinate system of the manufacturing cell.

10. The manufacturing system of claim 1, wherein:
each pallet is configured to support at least one workpiece mounting fixture having a mounting surface containing a plurality of apertures; and
at least one of the transport device and the first and second processing stations has a vacuum pressure source fluidly couplable to the apertures of the workpiece mounting fixture for generating vacuum pressure at the apertures for vacuum coupling of the workpiece to the mounting surface.

11. The manufacturing system of claim 10, wherein:
the pallets each have a pallet vacuum connector;
the transport device comprises:
at least one transport device vacuum pump;
a transport device vacuum connector mounted to the transport device and fluidly coupled to the transport device vacuum pump; and
the transport device vacuum connector is configured to sealingly engage with the pallet vacuum connector when the transport device engages the pallet, thereby providing vacuum pressure at the apertures of the mounting surface of the workpiece mounting fixture for maintaining vacuum coupling of the workpiece to the workpiece mounting fixture when the pallet is transported by the transport device.

12. The manufacturing system of claim 10, wherein:
the pallets each have a pallet vacuum connector;
the first and second processing stations each include a station vacuum connector fluidly coupled to a factory vacuum pressure source; and
the station vacuum connector is configured to sealingly engage with the pallet vacuum connector when the transport device places the pallet at the first or second processing station, thereby providing vacuum pressure at the apertures of the mounting surface of the workpiece mounting fixture for vacuum coupling of the workpiece to the workpiece mounting fixture when the workpiece is operated on by the robotic device.

13. The manufacturing system of claim 1, wherein:
the manufacturing cell includes at least one subcell having a cell boundary at least partially enclosing the subcell, the subcell containing the robotic device and the first and second processing stations, the cell boundary having at least one entrance for passage of a transport device into and out of the subcell, the entrance having at least one pass-through sensor and having an entrance barrier selectively configurable to either prevent or allow passage of the transport device through the entrance;
the transport device having a transport device signaling device configured to emit a transport device signal;
the pass-through sensor configured to sense the transport device signal when the transport device approaches the entrance; and
the controller, in response to the pass-through sensor sensing the transport device signal, is configured to command the entrance barrier to allow passage of the transport device through the entrance.

14. The manufacturing system of claim 13, wherein the subcell comprise at least one of the following:
a machining subcell for machining workpieces;
an inspection subcell for inspecting workpieces; and
a cleaning subcell for cleaning workpieces.

15. A manufacturing cell for processing workpieces, comprising:
a robotic device configured to operate on a workpiece supported on any one of a plurality of pallets, each of the pallets configured to be transported by a transport device;
a first processing station and a second processing station located within reach of the robotic device and each configured to support any one of the pallets in fixed position relative to the robotic device; and
a controller configured to coordinate the operation of the manufacturing cell in a manner allowing the robotic device to continuously operate on a workpiece supported by one of the plurality of pallets at the first processing station while another one of the plurality of pallets is transferred to or from the second processing station.

16. A method of processing workpieces, comprising:
supporting one or more workpieces on each of a plurality of pallets;
transporting, using a transport device, any one of the plurality of pallets to a first processing station located in a manufacturing cell within reach of a robotic device; and
operating, using the robotic device, on a workpiece supported by one of the plurality of pallets at the first processing station while another one of the plurality of pallets is transferred to or from a second processing station located within reach of the robotic device.

17. The method of claim 16, further comprising:
transporting any one of the plurality of pallets to and/or from a plurality of pallet stations.

18. The method of claim 17, wherein transporting any one of the plurality of pallets to and/or from the plurality of pallet stations comprises at least one of the following:
transporting any one of the plurality of pallets to and/or from a feed station configured to support any one of the plurality of pallets prior to transporting, via a transport device, from the feed station to one or more processing stations; and
transporting any one of the plurality of pallets to and/or from a buffer queuing station configured to temporarily support any one of the pallets in between processing operations at one of the processing stations.

19. The method of claim 16, wherein transporting the pallets comprises:
transporting the pallets using a conveyor system having a plurality of conveyor sections extending along transport device routes between the plurality of pallet stations.

20. The method of claim 16, further comprising:
coupling, using a locating system, any one of the pallets to either one of the first and second processing stations in a precise and repeatable location and orientation relative to the robotic device.

21. The method of claim 16, wherein coupling any one of the pallets to either one of the first and second processing stations comprises:
coupling, using at least one three-point locating system, any one of the pallets to either one of the first and second processing stations.

22. The method of claim 20, wherein coupling any one of the pallets to either one of the first and second processing stations comprises:
coupling a cup system, included with each of the pallets, to a cone system, included with each of the first and second processing stations;
wherein:
the cone system has locating cones; and
the cup system has locating cups configured to engage respectively with the locating cones.

23. The method of claim 16, further comprising at least one of the following:
reading, via an RFID read/write head, an RFID tag included with each pallet to allow a controller to positively identify the pallet located at the first processing station and/or at the second processing station; and
verifying, using a set of tooling features, the location of the pallet relative to a world coordinate system of the manufacturing cell.

24. The method of claim 16, wherein supporting one or more workpieces on each of the plurality of pallets comprises:
supporting one or more workpiece mounting fixtures on at least one of the pallets, at least one of the workpiece mounting fixtures having a mounting surface containing a plurality of apertures; and
mounting a workpiece on the mounting surface of the workpiece mounting fixture;
vacuum coupling, using a vacuum pressure source of the transport device, the workpiece to the mounting surface when transporting the pallet via the transport device; and
vacuum coupling, using a vacuum pressure source respectively of the first and second processing stations, the workpiece to the mounting surface when supporting the pallet at the first or second processing station.

25. The method of claim 24, wherein vacuum coupling the workpiece to the mounting surface when transporting the pallet via the transport device comprises:
moving the transport device into engagement with the pallet, the transport device having a transport device vacuum connector fluidly coupled to at least one transport device vacuum pump;
sealingly engaging the transport device vacuum connector with a pallet vacuum connector of the pallet when moving the transport device into engagement with the pallet; and
activating the vacuum pressure source to thereby generate vacuum pressure at the apertures of the mounting surface for vacuum coupling the workpiece to the workpiece mounting fixture.

26. The method of claim 25, wherein vacuum coupling the workpiece to the mounting surface when supporting the pallet at the first or second processing station comprises:
placing, using the transport device, the pallet at the first processing station and/or the second processing station, each having a station vacuum connector fluidly coupled to a factory vacuum pressure source;
sealingly engaging the station vacuum connector with a pallet vacuum connector of the pallet when placing the pallet at the first processing station and/or the second processing station; and
activating the factory vacuum pressure source to thereby generate vacuum pressure at the apertures of the mounting surface for vacuum coupling the workpiece to the workpiece mounting fixture at the first and/or second processing stations.

27. The method of claim 16, wherein:
moving the transport device toward an entrance of a subcell of the manufacturing cell having a subcell boundary at least partially enclosing the subcell, the entrance having at least one pass-through sensor and having an entrance barrier selectively configurable to either prevent or allow passage of the transport device through the entrance;
emitting a transport device signal using a transport device signaling device mounted on the transport device;
receiving, using the pass-through sensor, the transport device signal when the transport device approaches the entrance; and
commanding, using a controller in response to the pass-through sensor receiving the transport device signal, the entrance barrier to allow passage of the transport device through the entrance.
